(19) United States
(12) Patent Application Publication
(10) Pub. No.: US 2022/0280900 A1
(43) Pub. Date: Sep. 8, 2022

(54) MIXED MATRIX MEMBRANES AND METHODS OF MAKING AND USE THEREOF

(71) Applicant: BOARD OF REGENTS, THE UNIVERSITY OF TEXAS SYSTEM, Austin, TX (US)

(72) Inventors: Benny FREEMAN, Austin, TX (US); Theodore J. DILENSCHNEIDER, Elgin, TX (US); Kevin REIMUND, Austin, TX (US)

(21) Appl. No.: 17/637,918

(22) PCT Filed: Aug. 26, 2020
(86) PCT No.: PCT/US2020/047953

§ 371 Date: Feb. 24, 2022

Related U.S. Application Data
(60) Provisional application No. 62/892,439, filed on Aug. 27, 2019.

(51) Int. Cl. B01D 69/14; B01D 69/02; B01D 71/16; B01D 71/68; B01D 71/64; C02F 1/44

(52) U.S. Cl. CPC B01D 69/148; B01D 69/02; B01D 71/16; B01D 71/68; B01D 71/64; C02F 1/44; B01D 2325/02; B01D 2325/04

(57) ABSTRACT

Disclosed herein are mixed matrix membranes, the mixed matrix membranes comprising a metal organic framework CA dispersed in a continuous polymer phase and methods of making and use thereof. The mixed matrix membranes can comprise a plurality of metal organic framework particles comprising UiO-66-(COOH)₂ dispersed in a continuous polymer phase. The mixed matrix membranes can comprise a plurality of metal organic framework particles dispersed in a continuous polymer phase comprising polyethersulfone, polyphenylsulfone, Matrimid, Torlon, cellulose acetate, or combinations thereof. Also disclosed herein are mixed matrix membranes for separating a target ion from a non-target ion in a liquid medium. Also described herein methods of separating a target ion from a non-target ion in a liquid medium using a mixed matrix membrane, wherein the mixed matrix membrane comprises a plurality of metal organic framework particles dispersed in a continuous polymer phase.

### CROSS-REFERENCE TO RELATED APPLICATIONS

This application claims the benefit of priority to U.S. Provisional Application No. 62/892,439 filed Aug. 27, 2019, which is hereby incorporated herein by reference in its entirety.

### STATEMENT OF GOVERNMENT SUPPORT

This invention was made with government support under Grant No. DE-SC0019272 awarded by the Department of Energy. The government has certain rights in this invention.

### BACKGROUND

As transportation goes electric and renewable energy sources (e.g., solar and wind) gain higher percentages of total grid input, battery demand will significantly increase. Currently the only technology that is market ready to meet this increase in demand is the lithium ion battery and associated chemistries. Lithium, while only making up ˜10% of a lithium ion battery, is the critical element in their construction.

Future demand for lithium ion batteries for use in electric vehicles and the internet of things will necessitate an unprecedented expansion in lithium mining (Peiró et al. JOM, 2013, 65(8), 986-996); it is estimated that a three-fold increase of current lithium production will be needed to meet the rising demand for lithium. Finding innovative, cost effective, and efficient ways to extract lithium from current and untapped sources is integral to meeting this demand.

Currently over 95% of lithium production comes from Australia, Chile, Argentina, and China, while the United States only operates a single lithium mine and is over 50% dependent on lithium imports (“Mineral Commodity Summaries: Lithium,” U.S. Geological Survey, 2017; Swain. Separation and Purification Technology, 2017, 172, 388-403). Fracking has provided an abundant supply of lithium in the form of produced water to the United States; for example, produced water from the Eagle Ford Shale contains over 1000 ppm lithium. (Maguire-Boyle et al. Environ. Sci.: Processes Impacts, 2014, 16, 2237-2248). Produced water from hydraulic fracturing contains upwards of 1.2 g/L of lithium, however no current technology can effectively access this lithium supply, which is due at least in part to the high levels of sodium also present in the produced water.

There are two major sources of lithium: brine processing and hard rock mining/refining; the market is nearly split 50/50 between these two sources. Hard rock deposits are in known locations and can be brought online quickly to meet lithium production demand but are the costliest form of lithium production. Brine ponds, such as those in the Atacama Desert in Chile, are inexpensive to operate and produce the lowest cost lithium but can take 3-4 years to bring online for lithium production based on current technology (e.g., evaporation ponds). Currently, lithium is mined from brine deposits by allowing water to evaporate in a series of ponds (often reaching multiple square miles in area) where different minerals reach saturation and begin to precipitate. The last series of ponds is dedicated to removing magnesium, a major contaminant in the final extraction of lithium. Here, upwards of 50% of the lithium pumped from the brine deposits deep underground can be lost in coprecipitation with magnesium. In the final processing, where the brine is generally 6% lithium by weight and ˜40% by weight salts, sodium carbonate is added to precipitate lithium out as lithium carbonate to be sold on the market. If any trace magnesium or, to a lesser extent, calcium is present at this stage, the sodium carbonate will cause them to coprecipitate, ruining the final product. The concentration of magnesium to lithium can range from 7:1 to 50:1 in the brines, meaning that the further substantial losses of lithium in coprecipitation with magnesium is a substantial economic barrier for extracting lithium from brine processing using current technologies. Membranes that could selectively remove lithium from produced water and/or Mg from brine solutions would unlock strategically and economically beneficial supplies of lithium.

Since their discovery in the early 1960s, polymer-based reverse osmosis membranes have seen an increase in popularity for desalination plants and a decrease in price as membrane technology has improved. Traditional polymeric materials used in desalination membranes, such porous polyethylene terephthalate (PET) and polyamide-based nanofilters, exhibit limited selectivity between ions with virtually no selectivity between ions of the same valence (Zhang et al. Science Advances, 2018, 4(2), eeaq0066; Comrani et al. Desalination, 2013, 317, 184-192; Li et al. Desalination, 2015, 369, 26-36). PET nanofiltration membranes exposed to UV radiation for several hours can achieve selectivity between cations of the same valance (up to 10 for Li*/Na⁺), but adequate ion transport through the membrane requires a high applied voltage (e.g., up to 10 V), limiting their energy efficiency (Zhang et al. Science Advances, 2018, 4(2), eeaq0066; Wen et al. Advanced Functional Materials, 2016, 26, 5796-5803).

Similarly, materials such as MoS₂ and graphene oxide do not demonstrate significant ion selectivity, despite their small pore size (Zhang et al. Science Advances, 2018, 4(2), eeaq0066; Feng et al. Nature Materials, 2016, 15, 850-855).

Sorbents, such as manganese dioxide, and charged nanofiltration membranes have been proposed for use as a remedy to this selectivity problem. The sorbents excel at removing and concentrating the lithium from synthetic brines, but foul in the caustic environments of real brines due to hard metal, magnesium, and calcium poisoning (Paranthaman et al. Environ. Sci. Technol., 2017, 51, 13481-13486). Charged nanofiltration membranes exhibit high lithium/magnesium separation due to their differences in charge but require the brine to be diluted over 10× with water to work effectively (Comrani et al. Desalination, 2013, 317, 184-192). This dilution requirement is due to the charge density in a real brine solution (at 40% by weight salt) overcoming the charge density on the membrane; in other words the Debye length (the distance between a charged surface and its surroundings where the charge is ‘felt’) rapidly approaches zero as the ionic strength of the solution increases. New materials, relying on size sieving and chemical interactions instead of charge, need to be developed to realize these complicated separations (e.g., lithium/magnesium and lithium/calcium separations).

Current polymer membranes elute ions based on their hydrated radii. The smaller the hydrated radii, the faster the ion moves through the polymeric material. Therefore, as seen in Table 1, ions such as fluorine and lithium will elute last when compared to other monovalent anions and cations, respectively. These materials also tend to pass water orders of magnitude faster than the larger salt ions, so they are useful for desalination, but not for ion selectivity. If the ions could be dehydrated, lithium and fluorine are the smallest, and therefore would permeate first; materials with apertures between the hydrated and dehydrated radii of ions in aqueous solutions need to be developed to achieve this.

The compositions and methods discussed herein addresses these and other needs.

TABLE 1
Hydrated and Dehydrated Diameter and Hydration Free Energy of Ions

| | Li⁺ | Na⁺ | K⁺ | Rb⁺ | Mg²⁺ | F⁻ | Cl⁻ | NO₃⁻ | SO₄²⁻ |
|---|---|---|---|---|---|---|---|---|---|
| Hydrated | 7.64 | 7.16 | 6.62 | 6.58 | 8.56 | 6.8 | 7.6 | 6.7 | 7.58 |
| Diameter (Å) | | | | | | | | | |
| Dehydrated | 1.20 | 1.90 | 2.66 | 2.96 | 1.30 | 2.76 | 3.62 | 5.28 | 5.80 |
| Diameter (Å) | | | | | | | | | |
| Hydration Free | −475 | −365 | −295 | −275 | −1830 | −465 | −340 | −300 | −1080 |
| Energy (kJ mol⁻¹) | | | | | | | | | |

### SUMMARY

In accordance with the purposes of the disclosed compositions and methods, as embodied and broadly described herein, the disclosed subject matter relates to mixed matrix membranes and methods of making and use thereof.

Metal organic frameworks (MOFs) show promise as a technology capable of selectively separating monovalent ions from mixtures in solution while maintaining stability in a myriad of conditions. Recent studies show that the metal organic framework ZIF-8 selectively permeates lithium over sodium and other cations. While attractive from a separations standpoint, ZIF-8 is brittle and difficult to scale to a commercial process. Mixed matrix membranes (MMMs) comprising mixtures of polymers and metal organic frameworks can address these challenges as the mixed matrix membranes retain the selectivity of the metal organic framework as well as the scalable and robust mechanical properties of polymers.

Described herein are mixed matrix membranes comprising a plurality of metal organic framework particles dispersed in a continuous polymer phase, and methods of making and use thereof. For example, the mixed matrix membranes can comprise polymers and water stable metal organic frameworks (MOFs) for aqueous ion separations. The metal organic frameworks are dispersed into a polymer material that is substantially impermeable to water and ions relative to the metal organic frameworks. At a high weight loading of metal organic frameworks in the polymer (e.g., >20 wt %), the metal organic frameworks can form percolation channels that allow for selectivity towards ions of smaller crystal radii (e.g., Li⁺ and Cl⁺ permeate before Mg²⁺ and SO₃²⁻). The polymer acts as a ‘glue’ that provides the mixed matrix membrane with structural integrity, processability, and scalability. These metal organic framework-based mixed matrix membranes can selectively separate monovalent ions, such as Li⁺, K⁺, Na⁺, F⁻, and Cl⁻, from complex mixtures of divalents, such as Ca²⁺, Mg²⁺, SO₃²⁻, and CO₃²⁻, in high salinity environments.

Disclosed herein are mixed matrix membranes comprising a plurality of metal organic framework particles dispersed in a continuous polymer phase, wherein the plurality of metal organic framework particles comprise UiO-66-(COOH)₂. In another aspect, the metal organic framework particles comprise a derivative of UiO-66-(COOH)₂ or a functionalized UiO-66-(COOH)₂.

In some examples, the continuous polymer phase comprises a hydrophobic polymer, an amorphous polymer, or a combination thereof. In some examples, the continuous polymer phase comprises poly(amide imide), poly(ether-b-amide), polysulfone, a polymer derived from bisphenylsulfone, polyimide, polyether sulfone, polyphenylsulfone, polyvinylidene difluoride (PVDF), polybenzimidazole (PBI), polyamide, polyimide, cellulose acetate, derivatives thereof, or combinations thereof. In some examples, the continuous polymer phase comprises polysulfone, Matrimid, Torlon, cellulose acetate, derivatives thereof, or combinations thereof. In some examples, the continuous polymer phase comprises polyethersulfone, polyphenylsulfone, Matrimid, Torlon, cellulose acetate, or combinations thereof.

Also disclosed herein are mixed matrix membranes comprising a plurality of metal organic framework particles dispersed in a continuous polymer phase, wherein the continuous polymer phase comprises polyethersulfone, polyphenylsulfone, Matrimid, Torlon, cellulose acetate, or combinations thereof.

Also disclosed are mixed matrix membranes comprising a plurality of metal organic framework particles dispersed in a continuous polymer phase, wherein the continuous polymer phase comprises a cellulose polymer, and the mixed matrix membrane exhibits a Li to Mg selectivity in the range of at least 53.8:1 to 142.7: 1. In some aspects, the mixed matrix composition comprising cellulose polymer contains a plurality of metal organic framework UiO-66 particles or derivatives thereof. In another aspect of this embodiment, the cellulose polymer comprises cellulose acetate.

In some examples, each of the plurality the metal organic framework particles comprises a channel, e.g., an ion transport channel, traversing the metal organic framework particle from a first pore window to a second pore window, wherein the first pore window and the second pore window have an average pore window diameter; the mixed matrix membrane has a first surface and a second surface, with an average thickness therebetween; the plurality of metal organic framework particles have an average particle size, the average particle size being less than the average thickness of the mixed matrix membrane; and the channels of at least a portion of the plurality of metal organic framework particles form a percolation channel that traverses the average thickness of the mixed matrix membrane from the first surface to the second surface. In some examples, the mixed matrix membrane comprises a mixed matrix membrane for separating a target ion from a non-target ion in a liquid medium, wherein the target ion has a target ion crystal diameter and a target ion solvated diameter in the liquid medium; wherein the non-target ion has a non-target ion crystal diameter and a non-target ion solvated diameter in the liquid medium; wherein the average pore window diameter is greater than the target ion crystal diameter and less than or equal to the target ion solvated diameter; wherein the target ion crystal diameter is smaller than the non-target ion crystal diameter and the target ion has a lower energy of solvation than the non-target ion; wherein in the absence of the plurality of metal organic framework particles the continuous polymer phase is substantially less permeable to the target ion, the non-target ion, and the liquid medium than the plurality of metal organic framework particles; such that the mixed matrix membrane is permeable to at least the target ion and the liquid medium via the percolation channel.

Also disclosed herein are mixed matrix membranes for separating a target ion from a non-target ion in a liquid medium, the mixed matrix membranes comprising: a plurality of metal organic framework particles dispersed in a continuous polymer phase, wherein each of the plurality the metal organic framework particles comprises a channel traversing the metal organic framework particle from a first pore window to a second pore window, e.g., an ion transport channel, wherein the first pore window and the second pore window have an average pore window diameter; wherein the target ion has a target ion crystal diameter and a target ion solvated diameter in the liquid medium; wherein the non-target ion has a non-target ion crystal diameter and a non-target ion solvated diameter in the liquid medium; wherein the average pore window diameter is greater than the target ion crystal diameter and less than or equal to the target ion solvated diameter; wherein the target ion crystal diameter is smaller than the non-target ion crystal diameter and the target ion has a lower energy of solvation than the non-target ion; wherein the mixed matrix membrane has a first surface and a second surface, with an average thickness therebetween; wherein the plurality of metal organic framework particles have an average particle size, the average particle size being less than the average thickness of the mixed matrix membrane; wherein the channels of at least a portion of the plurality of metal organic framework particles form a percolation channel that traverses the average thickness of the mixed matrix membrane from the first surface to the second surface; wherein in the absence of the plurality of metal organic framework particles the continuous polymer phase is substantially less permeable to the target ion, the non-target ion, and the liquid medium than the plurality of metal organic framework particles; such that the mixed matrix membrane is permeable to at least the target ion and the liquid medium via the percolation channel.

The plurality of metal organic framework particles can, for example, comprise UiO-66, ZIF, HKUST-1, derivatives thereof, or combinations thereof. In some examples, the plurality of metal organic framework particles comprise UiO-66, derivatives thereof, or combinations thereof. In some examples, the plurality of metal organic framework particles comprise UiO-66, UiO-66-(COOH)₂, UiO-66-NH₂, UiO-66-SO₃H, UiO-66-Br, or combinations thereof. In some examples, the plurality of metal organic framework particles comprise UiO-66, UiO-66-(COOH)₂, UiO-66-SO₃H, UiO-66-Br, or combinations thereof. In some examples, the plurality of metal organic framework particles comprise UiO-66-(COOH)₂. In some examples, the plurality of metal organic framework particles comprise UiO-66-(COOH)₂, UiO-66-NH₂, or combinations thereof. In some examples, the plurality of metal organic framework particles comprise UiO-66-(COOH)₂ and the continuous polymer phase comprises cellulose acetate. In some examples, the plurality of metal organic framework particles are not UiO-66-NH₂. In some examples, the plurality of metal organic framework particles comprise ZIF-8, ZIF-7, derivatives thereof, or combinations thereof.

The plurality of metal organic framework particles can, for example, have an average particle size of from 1 nm to 1 μm. In some examples, the average particle size the plurality of metal organic framework particles is less than the average thickness of the mixed matrix membrane by an order of magnitude.

The average pore window diameter of the plurality of metal organic framework particles can, for example, be from 1 Å to 1 nm. In some examples, the average pore window diameter is from 2 Å to 4 Å, 2 A to 3 Å, 3 A to 4 Å, or from 5.5-6.5 Å.

In some examples, in the absence of the plurality of metal organic framework particles, the continuous polymer phase is substantially impermeable to the target ion, the non-target ion, and the liquid medium.

In some examples, the continuous polymer phase comprises a hydrophobic polymer, an amorphous polymer, or a combination thereof. In some examples, the continuous polymer phase comprises poly(amide imide), poly(ether-b-amide), polysulfone, a polymer derived from bisphenylsulfone, polyimide, polyether sulfone, polyphenylsulfone, polyvinylidene difluoride (PVDF), polybenzimidazole (PBI), polyamide, polyimide, cellulose acetate, derivatives thereof, or combinations thereof. In some examples, the continuous polymer phase comprises polysulfone, Matrimid, Torlon, cellulose acetate, derivatives thereof, or combinations thereof. In some examples, the continuous polymer phase comprises polyethersulfone, polyphenylsulfone, Matrimid, Torlon, cellulose acetate, or combinations thereof.

In some examples, the plurality of metal organic framework particles comprise UiO-66-(COOH)₂ and the continuous polymer phase comprises polysulfone, Matrimid, Torlon, cellulose acetate, derivatives thereof, or combinations thereof. In some examples, the plurality of metal organic framework particles comprise UiO-66-(COOH)₂, UiO-66-NH₂, or a combination thereof and the continuous polymer phase comprises polyethersulfone, polyphenylsulfone, Matrimid, Torlon, cellulose acetate, or combinations thereof. In some examples, the mixed matrix membrane does not comprise UiO-66-NH₂ and polysulfone.

In some examples, the mixed matrix membrane is substantially free of interfacial defects between the plurality of metal organic framework particles and the continuous polymer phase. In some examples, the continuous polymer phase is nonporous.

In some examples, the mixed matrix membrane comprises from greater than 0% to 90% by weight of the plurality of metal organic framework particles relative to the mixed matrix membrane. In some examples, the mixed matrix membrane comprises from 20% to 90% by weight of the plurality of metal organic framework particles relative to the mixed matrix membrane. In some examples, the mixed matrix membrane comprises from 30% to 90% by weight of the plurality of metal organic framework particles relative to the mixed matrix membrane. In some examples, the mixed matrix membrane comprises from 50% to 90% by weight of the plurality of metal organic framework particles relative to the mixed matrix membrane. In some examples, the mixed matrix membrane comprises from 60% to 90% by weight of the plurality of metal organic framework particles relative to the mixed matrix membrane. In some examples, the mixed matrix membrane comprises from 20% by weight to 60% by weight of the plurality of metal organic framework particles relative to the mixed matrix membrane. In some examples, the mixed matrix membrane comprises from 20% by weight to 40% by weight of the plurality of metal organic framework particles relative to the mixed matrix membrane.

The mixed matrix membrane can, for example, have an average thickness of from 50 nm to 50 μm. In some examples, the mixed matrix membrane has an average thickness of from 1 μm to 30 μm, or from 1 μm to 10 μm.

In some examples, the mixed matrix membrane forms a free standing membrane. In some examples, the mixed matrix membrane is supported by a substrate.

In some examples, the mixed matrix membrane exhibits a selectivity for the target ion over the non-target ion of from 2 to 2000. In some examples, the mixed matrix membrane exhibits a selectivity for the target ion over the non-target ion of 10 or more, 40 or more, 45 or more, or 50 or more.

The liquid medium can, for example, comprise water, tetrahydrofuran (THF), N-methyl-2-pyrrolidone (NMP), dimethylformamide (DMF), dimethyl sulfoxide (DMSO), dimethylacetamide, dichloromethane (CH₂Cl₂), ethylene glycol, ethanol, methanol, propanol, isopropanol, acetonitrile, chloroform, acetone, hexane, heptane, toluene, methyl acetate, ethyl acetate, or combinations thereof. In some examples, the liquid medium comprises water.

In some examples, the target ion, the non-target ion, or a combination thereof has a concentration in the liquid medium of from 0.001 M to 10 M. In some examples, the target ion, the non-target ion, or a combination thereof has a concentration in the liquid medium of from 0.1 M to 5 M, from 0.1 M to 1 M, or from 0.1 M to 0.3 M.

In some examples, the target ion comprises a monovalent ion and the non-target ions comprises a divalent ion. In some examples, the monovalent ion comprises an alkali metal cation, a halide anion, or a combination thereof. In some examples, the target ion comprises Li⁺ and the non-target ion comprises Mg²⁺, Ca²⁺, SO₄²⁻, or a combination thereof. In some examples, the target ion comprises Li⁺ and the non-target ion comprises Mg²⁺. In some examples, the target ion comprises Cl⁻ and the non-target ion comprises SO₄²⁻. In some examples, the target ion comprises F⁻ and the non-target ion comprises Cl⁻.

Also disclosed herein are methods of making any of the mixed matrix membranes described herein, the methods comprising: dispersing the plurality of metal organic framework particles in a first solvent, thereby forming a metal organic framework solution; dispersing a polymer in a second solvent, thereby forming a polymer solution; combining the metal organic framework solution and the polymer solution, thereby forming a mixture; and depositing the mixture. In some examples, the first solvent, the second solvent, or a combination thereof comprises tetrahydrofuran (THF), N-methyl-2-pyrrolidone (NMP), dimethylformamide (DMF), dimethyl sulfoxide (DMSO), dimethylacetamide, dichloromethane (CH₂Cl₂), ethylene glycol, ethanol, methanol, propanol, isopropanol, water, acetonitrile, chloroform, acetone, hexane, heptane, toluene, methyl acetate, ethyl acetate, or a combination thereof. In some examples, the first solvent, the second solvent, or a combination thereof comprises tetrahydrofuran (THF), N-methyl-2-pyrrolidone (NMP), or a combination thereof. In some examples, the first solvent and the second solvent are the same. In some examples, depositing the mixture comprises spin coating, drop-casting, zone casting, evaporative casting, dip coating, blade coating, spray coating, or combinations thereof. In some examples, the dispersing and combining steps comprise comprising gradient addition mixing. In some examples, the depositing step comprises doctor blade casting. In some examples, after depositing the mixture, the method further comprising evaporating the first solvent and/or the second solvent, or in lieu of evaporation further comprising immersing the deposited mixture in a nonsolvent that is miscible with the first and/or second solvents and in which the polymer is insoluble.

Also disclosed herein are methods of making any of the mixed matrix membranes disclosed herein, the methods comprising: combining the plurality of metal organic framework particles with a first solvent, thereby forming a metal organic framework solution; sonicating the metal organic framework solution to disperse the plurality of metal organic particles in the first solvent, thereby forming a sonicated metal organic framework solution; mixing a polymer with a second solvent, thereby forming a polymer solution; combining the sonicated metal organic framework solution with a portion of the polymer solution, thereby forming a first mixture and a remaining portion of the polymer solution; sonicating the first mixture, thereby forming a sonicated first mixture; combining the remaining portion of the polymer solution and the sonicated first mixture, thereby forming a second mixture; sonicating the second mixture, thereby forming a sonicated second mixture; depositing the sonicated second mixture, thereby forming a film; and evaporating the first solvent and/or the second solvent from the film, thereby forming the mixed matrix membrane. In some examples, the second mixture comprises at least 10% polymer by weight. In some examples, the first solvent, the second solvent, or a combination thereof comprises tetrahydrofuran (THF), N-methyl-2-pyrrolidone (NMP), dimethylformamide (DMF), dimethyl sulfoxide (DMSO), dimethylacetamide, dichloromethane (CH₂Cl₂), ethylene glycol, ethanol, methanol, propanol, isopropanol, water, acetonitrile, chloroform, acetone, hexane, heptane, toluene, methyl acetate, ethyl acetate, or a combination thereof. In some examples, the first solvent, the second solvent, or a combination thereof comprises tetrahydrofuran (THF), N-methyl-2-pyrrolidone (NMP), or a combination thereof. In some examples, the first solvent and the second solvent are the same. In some examples, depositing the mixture comprises spin coating, drop-casting, zone casting, evaporative casting, dip coating, blade coating, spray coating, or combinations thereof. In some examples, the depositing step comprises doctor blade casting.

Also disclosed herein are methods of making any of the mixed matrix membranes disclosed herein.

Also disclosed herein are methods of use of any of the mixed matrix membranes described herein, the methods comprising using the mixed matrix membrane to separate a target ion from a non-target ion in a liquid medium.

Also disclosed herein are methods of use of any of the mixed matrix membranes described herein, the methods comprising using the mixed matrix membrane for resource recovery or processing, mineral separation, ion separation, water purification, energy conversion, or a combination thereof.

Also disclosed herein are methods of use of any of the mixed matrix membranes described herein, the methods comprising using the mixed matrix membrane for the selective removal of Li from a high salinity aqueous solution in a continuous process.

Also disclosed herein are systems comprising any of the mixed matrix membranes described herein and a solution comprising a target ion and a non-target ion in a liquid medium, such that the target ion and the non-target ion are solvated. In some examples, the systems further comprise an electrode and a voltage source, wherein the voltage source and electrode are configured to apply a potential bias to generate an electric field gradient that influences the flow of the target ion through the mixed matrix membrane. Also disclosed herein are methods of use of the systems described herein, the methods comprising applying a potential bias to generate an electric field gradient that influences the flow of the target ion through the mixed matrix membrane to thereby separate the target ion from the non-target ion in the liquid medium.

Also disclosed herein are methods comprising separating a target ion from a non-target ion in a liquid medium using a mixed matrix membrane, wherein the mixed matrix membrane comprises a plurality of metal organic framework particles dispersed in a continuous polymer phase.

In some examples, the plurality of metal organic framework particles comprise UiO-66, ZIF, HKUST-1, derivatives thereof, or combinations thereof. In some examples, the plurality of metal organic framework particles comprise UiO-66, derivatives thereof, or combinations thereof. In some examples, the plurality of metal organic framework particles comprise UiO-66, UiO-66-(COOH)₂, UiO-66-NH₂, UiO-66-SO₃H, UiO-66-Br, or combinations thereof. In some examples, the plurality of metal organic framework particles comprise UiO-66, UiO-66-(COOH)₂, UiO-66-SO₃H, UiO-66-Br, or combinations thereof. In some examples, the plurality of metal organic framework particles comprise UiO-66-(COOH)₂. In some examples, the plurality of metal organic framework particles comprise UiO-66-(COOH)₂, UiO-66-NH₂, or combinations thereof. In some examples, the plurality of metal organic framework particles are not UiO-66-NH₂. In some examples, the plurality of metal organic framework particles comprise ZIF-8, ZIF-7, derivatives thereof, or combinations thereof. In some examples, n the plurality of metal organic framework particles have an average particle size of from 1 nm to 1 μm.

In some examples, the continuous polymer phase comprises a hydrophobic polymer, an amorphous polymer, or a combination thereof. In some examples, the continuous polymer phase comprises poly(amide imide), poly(ether-b-amide), polysulfone, a polymer derived from bisphenylsulfone, polyimide, polyether sulfone, polyphenylsulfone, polyvinylidene difluoride (PVDF), polybenzimidazole (PBI), polyamide, polyimide, derivatives thereof, or combinations thereof. In some examples, the continuous polymer phase comprises polysulfone, Matrimid, Torlon, derivatives thereof, or combinations thereof. In some examples, the continuous polymer phase comprises polyethersulfone, polyphenylsulfone, Matrimid, Torlon, or combinations thereof.

In some examples, the plurality of metal organic framework particles comprise UiO-66-(COOH)₂ and the continuous polymer phase comprises polysulfone, Matrimid, Torlon, derivatives thereof, or combinations thereof. In some examples, the plurality of metal organic framework particles comprise UiO-66-(COOH)₂, UiO-66-NH₂, or a combination thereof and the continuous polymer phase comprises polyethersulfone, polyphenylsulfone, Matrimid, Torlon, or combinations thereof. In some examples, the mixed matrix membrane does not comprise UiO-66-NH₂ and polysulfone.

In some examples, the mixed matrix membrane is substantially free of interfacial defects between the plurality of metal organic framework particles and the continuous polymer phase. In some examples, the continuous polymer phase is nonporous.

In some examples, the mixed matrix membrane comprises from greater than 0% to 90% by weight of the plurality of metal organic framework particles relative to the mixed matrix membrane. In some examples, the mixed matrix membrane comprises from 20% to 90% by weight of the plurality of metal organic framework particles relative to the mixed matrix membrane. In some examples, the mixed matrix membrane comprises from 30% to 90% by weight of the plurality of metal organic framework particles relative to the mixed matrix membrane. In some examples, the mixed matrix membrane comprises from 50% to 90% by weight of the plurality of metal organic framework particles relative to the mixed matrix membrane. In some examples, the mixed matrix membrane comprises from 60% to 90% by weight of the plurality of metal organic framework particles relative to the mixed matrix membrane. In some examples, the mixed matrix membrane comprises from 20% by weight to 60% by weight of the plurality of metal organic framework particles relative to the mixed matrix membrane. In some examples, the mixed matrix membrane comprises from 20% by weight to 40% by weight of the plurality of metal organic framework particles relative to the mixed matrix membrane.

In some examples, the mixed matrix membrane has an average thickness of from 50 nm to 50 μm. In some examples, the mixed matrix membrane has an average thickness of from 1 μm to 30 μm, or from 1 μm to 10 μm.

In some examples, the mixed matrix membrane forms a free standing membrane. In some examples, the mixed matrix membrane is supported by a substrate.

In some examples, the method exhibits a selectivity for the target ion over the non-target ion of from 2 to 2000. In some examples, the method exhibits a selectivity for the target ion over the non-target ion of 10 or more, 40 or more, 45 or more, or 50 or more.

In some examples, the liquid medium comprises water, tetrahydrofuran (THF), N-methyl-2-pyrrolidone (NMP), dimethylformamide (DMF), dimethyl sulfoxide (DMSO), dimethylacetamide, dichloromethane (CH₂Cl₂), ethylene glycol, ethanol, methanol, propanol, isopropanol, acetonitrile, chloroform, acetone, hexane, heptane, toluene, methyl acetate, ethyl acetate, or combinations thereof. In some examples, the liquid medium comprises water.

In some examples, the target ion, the non-target ion, or a combination thereof has a concentration in the liquid medium of from 0.001 M to 10 M. In some examples, the target ion, the non-target ion, or a combination thereof has a concentration in the liquid medium of from 0.1 M to 5 M, from 0.1 M to 1 M, or from 0.1 M to 0.3 M.

In some examples, the target ion comprises a monovalent ion and the non-target ions comprises a divalent ion. In some examples, the monovalent ion comprises an alkali metal cation, a halide anion, or a combination thereof. In some examples, the target ion comprises Li⁺ and the non-target ion comprises Mg²⁺, Ca²⁺, SO₄²⁻, or a combination thereof. In some examples, the target ion comprises Li⁺ and the non-target ion comprises Mg²⁺. In some examples, the target ion comprises Cl⁻ and the non-target ion comprises SO₄²⁻. In some examples, the target ion comprises F⁻ and the non-target ion comprises Cl⁻.

In some examples, each of the plurality the metal organic framework particles comprises a channel traversing the metal organic framework particle from a first pore window to a second pore window, e.g., an ion transport channel, wherein the first pore window and the second pore window have an average pore window diameter; the mixed matrix membrane has a first surface and a second surface, with an average thickness therebetween; the plurality of metal organic framework particles have an average particle size, the average particle size being less than the average thickness of the mixed matrix membrane; and the channels of at least a portion of the plurality of metal organic framework particles form a percolation channel that traverses the average thickness of the mixed matrix membrane from the first surface to the second surface. In some examples, the target ion has a target ion crystal diameter and a target ion solvated diameter in the liquid medium; the non-target ion has a non-target ion crystal diameter and a non-target ion solvated diameter in the liquid medium; the average pore window diameter is greater than the target ion crystal diameter and less than or equal to the target ion solvated diameter; the target ion crystal diameter is smaller than the non-target ion crystal diameter and the target ion has a lower energy of solvation than the non-target ion; in the absence of the plurality of metal organic framework particles the continuous polymer phase is substantially less permeable to the target ion, the non-target ion, and the liquid medium than the plurality of metal organic framework particles; such that the mixed matrix membrane is permeable to at least the target ion and the liquid medium via the percolation channel. In some examples, in the absence of the plurality of metal organic framework particles the continuous polymer phase is substantially impermeable to the target ion, the non-target ion, and the liquid medium. In some examples, the average particle size the plurality of metal organic framework particles is less than the average thickness of the mixed matrix membrane by an order of magnitude. In some examples, the average pore window diameter is from 1 Å to 1 nm. In some examples, the average pore window diameter is from 2 Å to 4 Å, 2 A to 3 Å, 3 A to 4 Å, or from 5.5-6.5 Å.

Additional advantages of the disclosed compositions and methods will be set forth in part in the description which follows, and in part will be obvious from the description. The advantages of the disclosed compositions and methods will be realized and attained by means of the elements and combinations particularly pointed out in the appended claims. It is to be understood that both the foregoing general description and the following detailed description are exemplary and explanatory only and are not restrictive of the disclosed compositions and methods, as claimed.

The details of one or more embodiments of the invention are set forth in the accompanying drawings and the description below. Other features, objects, and advantages of the invention will be apparent from the description and drawings, and from the claims.

### BRIEF DESCRIPTION OF THE FIGURES

The accompanying figures, which are incorporated in and constitute a part of this specification, illustrate several aspects of the disclosure, and together with the description, serve to explain the principles of the disclosure.

FIG. 1 is a schematic of the method of making a mixed matrix membrane comprising a metal organic framework and a polymer.

FIG. 2 is a schematic diagram of a permegear diffusion cell apparatus used to measure transport properties and selectivity.

FIG. 3 is an SEM image of a mixed matrix membrane comprising 40 wt % UiO-66-(COOH)₂ in polyethersulfone.

FIG. 4 is an SEM image of a mixed matrix membrane comprising 40 wt % UiO-66-(COOH)₂ in polyphenylsulfone.

FIG. 5 is an SEM image of a mixed matrix membrane comprising 40 wt % UiO-66-(COOH)₂ in polyphenylsulfone.

FIG. 6 shows the results of energy dispersive X-Ray (EDX) mapping of the section of the sample indicated by the rectangle in FIG. 5 indicated that zirconium was well dispersed throughout the structure.

FIG. 7 shows the results for single salt permeability tests through a mixed matrix membrane comprising 40 wt % UiO-66-(COOH)₂ in polysulfone.

FIG. 8 is a photograph of a sample of UiO-66-(COOH)₂ metal organic framework.

FIG. 9 is a photograph of a 25 micrometer thick mixed matrix membrane comprising 40 wt % UiO-66-(COOH)₂.

FIG. 10 is an SEM image of the mixed matrix membrane shown in FIG. 9.

FIG. 11 is an SEM image of the mixed matrix membrane shown in FIG. 9.

FIG. 12 is a photograph of a 16 micrometer thick mixed matrix membrane comprising 20 wt % UiO-66-(COOH)₂.

FIG. 13 is an SEM image of the mixed matrix membrane shown in FIG. 12.

FIG. 14 is a photograph of a 16 micrometer thick mixed matrix membrane comprising 40 wt % UiO-66-(COOH)₂.

FIG. 15 is a schematic of a separation using the mixed matrix membranes described herein.

FIG. 16 is a photograph of a 30 micrometer thick mixed matrix membrane comprising 40 wt % UiO-66-(COOH)₂ in polysulfone.

FIG. 17 is a plot of mass (normalized to donor cell concentration) versus time (0.3 M single salts) for a selectivity test performed on the mixed matrix membrane shown in FIG. 16 where LiCl was tested before MgCl₂.

FIG. 18 is a plot of mass (normalized to donor cell concentration) versus time (0.3 M single salts) for a selectivity test performed on the mixed matrix membrane shown in FIG. 16 where MgCl₂ was tested before LiCl.

FIG. 19 is a scanning electron microscopy (SEM) image of a mixed matrix membrane prepared using small UiO-66-(COOH)₂ particles embedded in polysulfone.

FIG. 20 is an SEM image of a mixed matrix membrane prepared using large UiO-66-(COOH)₂ particles embedded in polysulfone.

FIG. 21 is a plot of mass (normalized to donor cell concentration) versus time for a selectivity test performed on a mixed matrix membrane comprising 40 wt % UiO-66-(COOH)₂ in polysulfone using 1 M salt solutions.

FIG. 22 is a plot of mass (normalized to donor cell concentration) versus time for a selectivity test performed on a mixed matrix membrane comprising 40 wt % UiO-66-(COOH)₂ in polysulfone using 1 M salt solutions.

FIG. 23 is a plot of mass (normalized to donor cell concentration) versus time for a selectivity test performed on a mixed matrix membrane comprising 40 wt % UiO-66-NH₂ in polysulfone using 0.3 M solutions.

FIG. 24 is a photograph of a mixed matrix membrane comprising 40 wt % UiO-66(COOH)₂ in Torlon.

FIG. 25 is an SEM image of the mixed matrix membrane shown in FIG. 24.

FIG. 26 shows the results for single salt permeability tests at 1 Molar of each salt of MgCl₂ and LiCl through the mixed matrix membrane shown in FIG. 24.

FIG. 27 shows the results for single salt permeability tests at 1 Molar of each salt of MgCl₂ and LiCl through the mixed matrix membrane shown in FIG. 9.

FIG. 28 shows the results of 1 M single salt transport tests through a 50 micron thick MMM comprising 40 wt. % UiO-66-2(COOH) in CA 2.45.

FIG. 29 shows the results of 1 M single salt transport through a 10 micron thick MMM comprising 30 wt. % UiO-66-2(COOH) in CA 2.45.

FIG. 30 shows the results of 1 M single salt transport through a 100 micron thick MMM comprising 28.5 wt. % UiO-66-2(COOH) in CA 2.45.

FIG. 31 shows the results of 1 M single salt transport through a 10 micron thick pure CA 2.45.

FIG. 32 shows the results of 1 M single salt transport through a 70 micron thick pure CA 1.75.

FIG. 33 shows the results of 1 M single salt transport through a 30 micron thick 30 wt. % UiO-66-2(COOH) in CA 2.45.

### DETAILED DESCRIPTION

The compositions, devices, and methods described herein may be understood more readily by reference to the following detailed description of specific aspects of the disclosed subject matter and the Examples included therein.

Before the present compositions, devices, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

General Definitions

In this specification and in the claims that follow, reference will be made to a number of terms, which shall be defined to have the following meanings:

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “the compound” includes mixtures of two or more such compounds, reference to “an agent” includes mixture of two or more such agents, and the like.

“Optional” or “optionally” means that the subsequently described event or circumstance can or cannot occur, and that the description includes instances where the event or circumstance occurs and instances where it does not.

Mixed Matrix Membranes

Metal organic frameworks (MOFs) show promise as a technology capable of selectively separating monovalent ions from mixtures in solution while maintaining stability in a myriad of conditions. For example, metal organic frameworks that are ion selective include ZIF-8 and UiO-66-NH₂, which selectively permeate lithium over sodium and other cations and fluorine over chlorine and other anions, respectively (Zhang et al. Science Advances, 2018, 4(2), eeaq0066). Metal organic frameworks comprise metal nodes connected by organic ligands that form a highly crystalline structure with well defined, angstrom sized apertures. The aperture of many metal organic framework materials is between the hydrated radii and dehydrated radii of monovalent ions, such that the ions must shed or reorganize their associated waters to enter the metal organic framework structure. Therefore, the ions permeate the metal organic framework based on their dehydrated diameter, or hydration energy, meaning that Li, the smaller dehydrated but larger hydrated cation, permeates before Na, the larger dehydrated but smaller hydrated cation. While attractive from a separation standpoint, metal organic frameworks are brittle and difficult to scale to a commercial process. Meanwhile, polymeric membranes are scalable and offer robust mechanical properties, but cannot selectively separate monovalent ions.

Disclosed herein are mixed matrix membranes comprising a plurality of metal organic framework particles dispersed in a continuous polymer phase. For example, at least a portion of the plurality of metal organic framework particles can form a percolating network within the continuous polymer phase. In some examples, the mixed matrix membrane is substantially free of interfacial defects between the plurality of metal organic framework particles and the continuous polymer phase.

“Phase,” as used herein, generally refers to a region of a material having a substantially uniform composition which is a distinct and physically separate portion of a heterogeneous system. The term “phase” does not imply that the material making up a phase is a chemically pure substance, but merely that the chemical and/or physical properties of the material making up the phase are essentially uniform throughout the material, and that these chemical and/or physical properties differ significantly from the chemical and/or physical properties of another phase within the material. Examples of physical properties include density, thickness, aspect ratio, specific surface area, porosity and dimensionality. Examples of chemical properties include chemical composition.

“Continuous,” as used herein, generally refers to a phase such that all points within the phase are directly connected, so that for any two points within a continuous phase, there exists a path which connects the two points without leaving the phase.

The continuous polymer phase in the absence of the plurality of metal organic framework particles is substantially less permeable (e.g., to ions, solutions, and/or liquids) than the plurality of metal organic framework particles. In some examples, the continuous polymer phase in the absence of the plurality of metal organic framework particles is substantially impermeable (e.g., to ions, solutions, and/or liquids). In some examples, the continuous polymer phase is nonporous, wherein as used herein “nonporous” means that the continuous polymer phase is essentially free of permanent holes that span the mixed matrix membrane from one surface to the opposite surface; in a preferred embodiment, the continuous polymer phase has no permanent holes that span the mixed matrix membrane; accordingly, for example, in a lithium ion separation system, transport of lithium ions across the mixed matrix membrane will be solely or substantially solely a function of the plurality of metal organic frame work particles dispersed in the continuous polymer phase. The nonporous nature of the continuous polymer phase can be determined, for example, by scanning electron microscopy or other suitable imaging techniques.

The continuous polymer phase can comprise any suitable polymer. For example the continuous polymer phase can comprise a hydrophobic polymer, an amorphous polymer, or a combination thereof. Examples of polymers include, but are not limited to, those listed in Table 2.

TABLE 2
Examples of polymers.

| Polymer Class | Examples |
|---|---|
| Polysulfones | Polysulfone (PSU), Polyethersulfone (PES), Polyphenylsulfone |
| | (PPSU), Poly(ether-ether sulfone) (PEES), Poly(aryl-ether sulfone) |
| | (PAES), Sulfonated derivatives therefore including Sulfonated PES |
| | (SPES), bisphonenolsulfone (BPS) |
| Polyamides | Nylon (6), Nylon (6,6), Nylon (10), Nylon (10,10), Nylon (12), Nylon |
| | (12,12), Nylon (6,10), Nylon (6,12), Nylon (10,12), “Kevlar”, |
| | “Twaron”, poly(2-oxazoline) |
| Polyimides | Polyimide P-84, Matrimid 5218 |
| Poly(amide-imide)s | Torlon |
| Polyphenylenes | Poly(ether ketone) (PEK), Poly(ether-ether ketone) (PEEK), |
| | Sulfonated poly(ether-ether ketone) (SPEEK), Poly(phenylene oxide) |
| Polyethers | Poly(oxymethylene), Poly(ethyleneoxide), Poly(propylene glycol), |
| | Poly(2-propylene glycol), Poly(tetramethylene glycol), Copolymers |
| | thereof |
| Poly(ether-b-amide) | PEBAX 1067, PEBAX 1657, PEBAX 2533, PEBAX 3533 |
| Polystyrenes | Polystyrene, Sulfonated polystyrene, poly(acrylonitrile-b-styrene) |
| | (ABS), poly(styrene-b-ethylene oxide), poly(styrene-b-lactic acid), |
| | poly(styrene-b-caprolactam) |
| Polythiophenes | Poly(3,4-ethylenedioxythiophene) (PEDOT), poly(3-hexylthiophene- |
| | 2,5-diyl) (P3HT) |
| Polyacrylates | Poly(methyl methacrylate) (PMMA), poly(ethyl methacrylate) |
| | (PEMA) |
| Polybenzimidazoles | Celazole, |
| Fluoro- and chloro- | Poly(vinylidene fluoride) (PVDF), poly(ethylene |
| polymers | chlorotrifluoroethylene) (ECTFE), poly(vinyl chloride) (PVC) |
| Polycarbonates | Bisphenol A polycarbonate |
| Cellulosic polymers | Cellulose acetate, cellulose triacetate, cellulose nitrate, cellulose |
| | acetate butyrate |
| Others | Poly[1-trimethylsilyl)-1-propyne] |

In some examples, the continuous polymer phase can comprise a polymer selected from the group consisting of poly(amide imide) (e.g., Torlon), poly(ether-b-amide) (e.g., PEBAX), polysulfone, a polymer derived from bisphenylsulfone, polyimide (e.g., Matrimid), polyethersulfone, polyphenylsulfone, polyvinylidene difluoride (PVDF), polybenzimidazole (PBI), polyamide, polyimide, derivatives thereof, and combinations thereof. In some examples, the continuous polymer phase can comprise polysulfone, Matrimid, Torlon, derivatives thereof, or combinations thereof. In some examples, the continuous polymer phase can comprise polyethersulfone, polyphenylsulfone, Matrimid, Torlon, or combinations thereof. For example, disclosed herein are mixed matrix membranes comprising a plurality of metal organic framework particles dispersed in a continuous polymer phase, wherein the continuous polymer phase comprises polyethersulfone, polyphenylsulfone, Matrimid, Torlon, or combinations thereof. In some examples, the continuous polymer phase can comprise cellulose acetate, cellulose triacetate, cellulose nitrate, cellulose acetate butyrate, and derivatives of these and other cellulose polymers.

The plurality of metal organic framework particles can comprise any suitable metal organic framework. A metal organic framework (MOF) comprises a plurality of metal nodes (e.g., a metal, a metal oxide, a metal cluster, a metal oxide cluster, etc.) connected by organic linkers to form a porous crystalline structure. In some examples, the metal nodes can comprise a transition metal, an alkali metal, an alkaline earth metal, an icosagen, or combinations thereof.

For example, the metal organic framework can comprise metal nodes comprising Co, Cu, Cd, Fe, Mg, Mn, Ni, Ru, Zn, Zr, or combinations thereof. In some examples, the metal organic framework can comprise metal nodes comprising Zr. Examples of suitable organic linkers include, but are not limited to, 1,3,5-benzenetribenzoate (BTB); 1,4-benzenedicarboxylate (BDC); cyclobutyl 1,4-benzenedicarboxylate (CB BDC); 2-amino 1,4 benzenedicarboxylate (H₂N BDC); tetrahydropyrene 2,7-dicarboxylate (HPDC); terphenyl dicarboxylate (TPDC); 2,6 naphthalene dicarboxylate (2,6-NDC); pyrene 2,7-dicarboxylate (PDC); biphenyl dicarboxylate (BDC); or any di-, tri-, or tetra-carboxylate having phenyl compounds. Examples of metal organic frameworks include, but are not limited to, UiO-66, ZIF, HKUST-1, derivatives thereof, and combinations thereof. In some examples, the plurality of metal organic framework particles can comprise a functionalized metal organic framework, for example, MOF particles functionalized with crown ether moieties in or on the MOF channel as a means to restrict the pore size or enhance the binding capacity of the MOF.

In some examples, the metal organic framework comprises ZIF-8, ZIF-7, derivatives thereof, or combinations thereof. In some examples, the metal organic framework comprises UiO-66, derivatives thereof, or combinations thereof. The metal organic-framework can, for example, be selected from the group consisting of UiO-66, UiO-66-(COOH)₂, UiO-66-NH₂, UiO-66-SO₃H, UiO-66-Br, and combinations thereof. In some examples, the plurality of metal organic framework particles comprise UiO-66, UiO-66-(COOH)₂, UiO-66-SO₃H, UiO-66-Br, or combinations thereof. In certain examples, the metal organic framework can comprise UiO-66-(COOH)₂, UiO-66-NH₂, or combinations thereof. In some examples, the plurality of metal organic framework particles comprise UiO-66-(COOH)₂. For example, disclosed herein are mixed matrix membranes comprising a plurality of metal organic framework particles dispersed in a continuous polymer phase, wherein the plurality of metal organic framework particles comprise UiO-66-(COOH)₂. In some examples, the plurality of metal organic framework particles are not UiO-66-NH₂. In some examples, the mixed matrix membrane does not comprise UiO-66-NH₂ and polysulfone.

In some examples, the plurality of metal organic framework particles comprise UiO-66-(COOH)₂ and the continuous polymer phase comprises polysulfone, Matrimid, Torlon, cellulose acetate, derivatives thereof, or combinations thereof. In some examples, the plurality of metal organic framework particles comprise UiO-66-(COOH)₂, UiO-66-NH₂, or a combination thereof and the continuous polymer phase comprises polyethersulfone, polyphenylsulfone, Matrimid, Torlon, cellulose acetate, or combinations thereof. The plurality of metal organic framework particles can have an average particle size. “Average particle size” and “mean particle size” are used interchangeably herein, and generally refer to the statistical mean particle size of the particles in a population of particles. For example, the average particle size for a plurality of particles with a substantially spherical shape can comprise the average diameter of the plurality of particles. For a particle with a substantially spherical shape, the diameter of a particle can refer, for example, to the hydrodynamic diameter. As used herein, the hydrodynamic diameter of a particle can refer to the largest linear distance between two points on the surface of the particle. For an anisotropic particle, the average particle size can refer to, for example, the average maximum dimension of the particle (e.g., the length of a rod shaped particle, the diagonal of a cube shape particle, the bisector of a triangular shaped particle, etc.). For an anisotropic particle, the average particle size can refer to, for example, the hydrodynamic size of the particle. Mean particle size can be measured using methods known in the art, such as evaluation by scanning electron microscopy, transmission electron microscopy, and/or dynamic light scattering. As used herein, the average particle size is determined by scanning electron microscopy.

The plurality of metal organic framework particles can, for example, have an average particle size of 1 nanometer (nm) or more (e.g., 2 nm or more, 3 nm or more, 4 nm or more, 5 nm or more, 6 nm or more, 7 nm or more, 8 nm or more, 9 nm or more, 10 nm or more, 15 nm or more, 20 nm or more, 25 nm or more, 30 nm or more, 35 nm or more, 40 nm or more, 45 nm or more, 50 nm or more, 55 nm or more, 60 nm or more, 65 nm or more, 70 nm or more, 75 nm or more, 80 nm or more, 85 nm or more, 90 nm or more, 95 nm or more, 100 nm or more, 125 nm or more, 150 nm or more, 175 nm or more, 200 nm or more, 225 nm or more, 250 nm or more, 275 nm or more, 300 nm or more, 350 nm or more, 400 nm or more, 450 nm or more, 500 nm or more, 600 nm or more, 700 nm or more, or 800 nm or more).

In some examples, the plurality of metal organic framework particles can have an average particle size of 1 micrometer (micron, μm) or less (e.g., 900 nm or less, 800 nm or less, 700 nm or less, 600 nm or less, 500 nm or less, 450 nm or less, 400 nm or less, 350 nm or less, 300 nm or less, 275 nm or less, 250 nm or less, 225 nm or less, 200 nm or less, 175 nm or less, 150 nm or less, 125 nm or less, 100 nm or less, 95 nm or less, 90 nm or less, 85 nm or less, 80 nm or less, 75 nm or less, 70 nm or less, 65 nm or less, 60 nm or less, 55 nm or less, 50 nm or less, 45 nm or less, 40 nm or less, 35 nm or less, 30 nm or less, 25 nm or less, 20 nm or less, 15 nm or less, 10 nm or less, 9 nm or less, 8 nm or less, 7 nm or less, 6 nm or less, or 5 nm or less).

The average particle size of the plurality of metal organic framework particles can range from any of the minimum values described above to any of the maximum values described above. For example, the plurality of metal organic framework particles can have an average particle size of from 1 nm to 1 μm (e.g., from 1 nm to 900 nm, from 1 nm to 800 nm, from 1 nm to 700 nm, from 1 nm to 600 nm, from 1 nm to 500 nm, from 1 nm to 400 nm, from 1 nm to 300 nm, from 1 nm to 200 nm, from 1 nm to 100 nm, from 5 nm to 100 nm, from 10 nm to 100 nm, from 25 nm to 100 nm, or from 50 nm to 100 nm).

In some examples, the plurality of metal organic framework particles can be substantially monodisperse. “Monodisperse” and “homogeneous size distribution,” as used herein, and generally describe a population of particles where all of the particles are the same or nearly the same size. As used herein, a monodisperse distribution refers to particle distributions in which 80% of the distribution (e.g., 85% of the distribution, 90% of the distribution, or 95% of the distribution) lies within 25% of the median particle size (e.g., within 20% of the average particle size, within 15% of the average particle size, within 10% of the average particle size, or within 5% of the average particle size).

The average particle size of the plurality of metal organic framework particles can be selected in view of a variety of factors. For example, the average particle size of the plurality of metal organic framework particles can be selected based on the average thickness of the mixed matrix membrane, e.g. such that the average particle size of the plurality of metal organic framework particles is less than the average thickness of the mixed matrix membrane. In some examples, the average particle size of the plurality of metal organic framework particles can be less than the average thickness of the mixed matrix membrane by an order of magnitude. If the average particle size of the metal organic framework particle is on the same size order as the resulting mixed matrix membrane thickness, defects can be formed during casting of the films for example due to interactions with the casting substrate or due to the casting blade/technique. For example, the metal organic particles can interact either more favorably or less favorably with the substrate, causing the metal organic framework particles to separate from the polymer or agglomerate away from the casting substrate, respectively. For example, if a casting blade is used to deposit the polymer/metal organic framework/solvent system onto a substrate, then the average particle size of the metal organic framework particles needs to be less than the height at which the casting blade is set. Otherwise, the metal organic framework particles can contact the blade during casting and streak across the surface, causing macro-sized defects in the film. Furthermore, the average particle size of the metal organic framework particles can be selected in view of the desired mechanical properties of the mixed matrix membrane. For example, the average particle size of the metal organic framework particles can be inversely related (e.g., the larger the average particle size of the metal organic framework particles, the weaker the mechanical properties of the mixed matrix membrane are).

The mixed matrix membrane can have an average thickness. “Average thickness” and “mean thickness” are used interchangeably herein. Average thickness can be measured using methods known in the art, such as evaluation by profilometry, cross-sectional electron microscopy, atomic force microscopy (AFM), ellipsometry, veneer calipers, micrometer gauges, or combinations thereof. As used herein, the average thickness is determined by micrometer gauges.

The mixed matrix membrane can, for example, have an average thickness of 50 nm or more (e.g., 60 nm or more, 70 nm or more, 80 nm or more, 90 nm or more, 100 nm or more, 125 nm or more, 150 nm or more, 175 nm or more, 200 nm or more, 225 nm or more, 250 nm or more, 300 nm or more, 350 nm or more, 400 nm or more, 450 nm or more, 500 nm or more, 600 nm or more, 700 nm or more, 800 nm or more, 900 nm or more, 1 μm or more, 1.5 μm or more, 2 μm or more, 2.5 μm or more, 3 μm or more, 3.5 μm or more, 4 μm or more, 4.5 μm or more, 5 μm or more, 6 μm or more, 7 μm or more, 8 μm or more, 9 μm or more, 10 μm or more, 15 μm or more, 20 μm or more, 25 μm or more, 30 μm or more, 35 μm or more, or 40 μm or more).

In some examples, the mixed matrix membrane can have an average thickness of 50 μm or less (e.g., 45 μm or less, 40 μm or less, 35 μm or less, 30 μm or less, 25 μm or less, 20 μm or less, 15 μm or less, 10 μm or less, 9 μm or less, 8 μm or less, 7 μm or less, 6 μm or less, 5 μm or less, 4.5 μm or less, 4 μm or less, 3.5 μm or less, 3 μm or less, 2.5 μm or less, 2 μm or less, 1.5 μm or less, 1 μm or less, 900 nm or less, 800 nm or less, 700 nm or less, 600 nm or less, 500 nm or less, 450 nm or less, 400 nm or less, 350 nm or less, 300 nm or less, 250 nm or less, 225 nm or less, 200 nm or less, 175 nm or less, 150 nm or less, 125 nm or less, or 100 nm or less).

The average thickness of the mixed matrix membrane can range from any of the minimum values described above to any of the maximum values described above. For example, the mixed matrix membrane can have an average thickness of from 50 nm to 50 μm (e.g., from 100 nm to 50 μm, from 500 nm to 50 μm, from 500 nm to 20 μm, 1 μm to 30 μm, from 1 μm to 10 μm, from 500 nm to 10 μm, or from 500 nm to 5 μm). The average thickness of the mixed matrix membrane can be selected in view of a variety of factors. For example, the average thickness of the mixed matrix membrane can be selected in view of the average particle size of the plurality of metal organic framework properties, the desired mechanical properties of the mixed matrix membrane, the desired transport properties of the mixed matrix membrane, or combinations thereof.

The mixed matrix membrane can, in some examples, form a free standing membrane. In some examples, the mixed matrix membrane is supported by a substrate. Examples of suitable substrates include, but are not limited to, polymers (e.g., porous polymers), glass fibers, glass, quartz, silicon, non-woven fibers, and combinations thereof.

The mixed matrix membranes can comprise greater than 0% by weight of the plurality of metal organic framework particles relative to the mixed matrix membrane (e.g., 1% or more, 2% or more, 3% or more, 4% or more, 5% or more, 6% or more, 7% or more, 8% or more, 9% or more, 10% or more, 15% or more, 20% or more, 25% or more, 30% or more, 35% or more, 40% or more, 45% or more, 50% or more, 55% or more, 60% or more, 65% or more, 70% or more, 75% or more, or 80% or more). In some examples, the mixed matrix membrane can comprise 90% or less by weight of the plurality of metal organic framework particles relative to the mixed matrix membrane (e.g., 85% or less, 80% or less, 75% or less, 70% or less, 65% or less, 60% or less, 55% or less, 50% or less, 45% or less, 40% or less, 35% or less, 30% or less, 25% or less, 20% or less, 15% or less, 10% or less, 9% or less, 8% or less, 7% or less, 6% or less, or 5% or less). The average weight loading of the plurality of metal organic framework particles in the mixed matrix membrane can range from any of the minimum values described above to any of the maximum values described above. For example, the mixed matrix membrane can comprise from greater than 0% to 90% by weight of the plurality of metal organic framework particles relative to the mixed matrix membrane (e.g., from greater than 0% to 45%, from 45% to 90%, from greater than 0% to 30%, from 30% to 60%, from 60% to 90%, from greater than 0% to 80%, from 10% to 90%, from 20% to 90%, from 20% to 55%, from 55% to 90%, from 20% to 40%, from 40% to 60%, from 60% to 90%, from 20% to 80%, from 30% to 90%, from 50% to 90%, from 60% to 90%, from 20% to 60%, or from 20% to 40%). In some examples, the mixed matrix membrane can comprise 20% or more by weight of the plurality of metal organic framework particles relative to the mixed matrix membrane. In some examples, the mixed matrix membrane can comprise from 20% to 90% by weight of the plurality of metal organic framework particles relative to the mixed matrix membrane. In some examples, the metal organic framework can be distributed substantially homogeneously throughout the mixed matrix membrane.

The average weight loading the plurality of metal organic framework particles in the mixed matrix membrane can be selected in view of a variety of factors. For example, average weight loading the plurality of metal organic framework particles in the mixed matrix membrane can be selected in view of the desired mechanical and transport properties of the mixed matrix membrane. For example, the average weight loading of the plurality of metal organic framework particles in the mixed matrix membrane can be inversely related to the mechanical properties and directly related to the transport properties. As the average weight loading of the plurality of metal organic framework particles in the mixed matrix membrane is increased, the mechanical properties of the mixed matrix membrane become worse. For example, as the average weight loading of the plurality of metal organic framework particles in the mixed matrix membrane is increased, the mixed matrix membranes can become more brittle and likely to crack under stress. Conversely, the transport properties of the mixed matrix membrane can improve as the average weight loading of the plurality of metal organic framework particles in the mixed matrix membrane increases. For example, the water uptake of the mixed matrix membranes can increase as the average weight loading of the plurality of metal organic framework particles (e.g., UiO-66-(COOH)₂) in the mixed matrix membranes increases; this can indicate an increase in aqueous pathways for ions of interest to travel through the mixed matrix membrane when used for ion separations in aqueous solutions. The average weight loading of the plurality of metal organic framework particles in the mixed matrix membrane can be selected in view of this tradeoff between the decreasing mechanical properties (e.g., increasing brittleness) and increasing transport properties as the average weight loading of the plurality of metal organic framework particles in the mixed matrix membrane increases.

Each of the plurality of metal organic framework particles can comprise a channel traversing the metal organic framework particle from a first pore window to a second pore window, and wherein the first pore window and the second pore window have an average pore window diameter. As used herein, “a channel” and “the channel” are meant to include any number of channels. In certain examples, the channels are ion transport channels. Thus, for example, “the channel” includes one or more channels. In some examples, each of the plurality of metal organic framework particles can comprise a plurality of channels, each traversing the metal organic framework particle from a first pore window to a second pore window, and wherein the first pore window and the second pore window have an average pore window diameter.

“Average pore window diameter” and “mean pore window diameter” are used interchangeably herein. Average pore window diameter can be measured using methods known in the art, such as evaluation by gas sorption and desorption isotherms.

The average pore window diameter can, for example, be 1 Angstrom (Å) or more (e.g., 1.25 Å or more, 1.5 Å or more, 1.75 Å or more, 2 Å or more, 2.25 Å or more, 2.5 Å or more, 2.75 Å or more, 3 Å or more, 3.25 Å or more, 3.5 Å or more, 3.75 Å or more, 4 Å or more, 4.25 Å or more, 4.5 Å or more, 4.75 Å or more, 5 Å or more, 5.25 Å or more, 5.5 Å or more, 5.75 Å or more, 6 Å or more, 6.25 Å or more, 6.5 Å or more, 6.75 Å or more, 7 Å or more, 7.25 Å or more, 7.5 Å or more, 7.75 Å or more, 8 Å or more, 8.25 Å or more, 8.5 Å or more, 8.75 Å or more, or 9 Å or more).

In some examples, the average pore window diameter can be 1 nm or less (e.g., 9.75 Å or less, 9.5 Å or less, 9.25 Å or less, 9 Å or less, 8.75 Å or less, 8.5 Å or less, 8.25 Å or less, 8 Å or less, 7.75 Å or less, 7.5 Å or less, 7.25 Å or less, 7 Å or less, 6.75 Å or less, 6.5 Å or less, 6.25 Å or less, 6 Å or less, 5.75 Å or less, 5.5 Å or less, 5.25 Å or less, 5 Å or less, 4.75 Å or less, 4.5 Å or less, 4.25 Å or less, 4 Å or less, 3.75 Å or less, 3.5 Å or less, 3.25 Å or less, 3 Å or less, 2.75 Å or less, 2.5 Å or less, 2.25 Å or less, or 2 Å or less).

The average pore window diameter can range from any of the minimum values described above to any of the maximum values described above. For example, the average pore window diameter can be from 1 Å to 1 nm (e.g., from 1 Å to 9 Å, from 1 Å to 8 Å, from 1 Å to 7 Å, from 2 Å to 4 Å, from 2 Å to 3 Å, from 3 Å to 4 Å, or from 5.5-6.5 Å). In some examples, the average pore window diameter can be substantially monodisperse. The average pore window diameter can be selected in view of a variety of factors. For example, the average pore window diameter can be selected in view of the identity of the target ion and the non-target ion when the mixed matrix membranes for separating a target ion from a non-target ion.

In some examples, each of the plurality the metal organic framework particles comprises a channel traversing the metal organic framework particle from a first pore window to a second pore window, wherein the first pore window and the second pore window have an average pore window diameter; the mixed matrix membrane has a first surface and a second surface, with an average thickness therebetween; the plurality of metal organic framework particles have an average particle size, the average particle size being less than the average thickness of the mixed matrix membrane; and the channels of at least a portion of the plurality of metal organic framework particles form a percolation channel that traverses the average thickness of the mixed matrix membrane from the first surface to the second surface.

In some examples, each of the plurality the metal organic framework particles comprises a plurality of channels, each channel traversing the metal organic framework particle from a first pore window to a second pore window, wherein the first pore window and the second pore window have an average pore window diameter; the mixed matrix membrane has a first surface and a second surface, with an average thickness therebetween; the plurality of metal organic framework particles have an average particle size, the average particle size being less than the average thickness of the mixed matrix membrane; and at least a portion of the plurality of channels of at least a portion of the plurality of metal organic framework particles form a percolation channel that traverses the average thickness of the mixed matrix membrane from the first surface to the second surface.

Disclosed herein are mixed matrix membranes for separating a target ion from a non-target ion in a liquid medium. In some examples, the mixed matrix membranes comprise a mixed matrix membrane for separating a target ion from a non-target ion in a liquid medium, wherein the target ion has a target ion crystal diameter and a target ion solvated diameter in the liquid medium; wherein the non-target ion has a non-target ion crystal diameter and a non-target ion solvated diameter in the liquid medium; wherein the average pore window diameter is greater than the target ion crystal diameter and less than or equal to the target ion solvated diameter; wherein the target ion crystal diameter is smaller than the non-target ion crystal diameter and the target ion has a lower energy of solvation than the non-target ion; wherein in the absence of the plurality of metal organic framework particles the continuous polymer phase is substantially less permeable to the target ion, the non-target ion, and the liquid medium than the plurality of metal organic framework particles; such that the mixed matrix membrane is permeable to at least the target ion and the liquid medium via the percolation channel.

Disclosed herein are mixed matrix membranes for separating a target ion from a non-target ion in a liquid medium, the mixed matrix membranes comprising a metal organic framework dispersed in a continuous polymer phase. The mixed matrix membranes (MMMs) comprising a mixture of a polymer and metal organic framework can retain the selectivity of the metal organic framework as well as the scalable and robust mechanical properties of the polymer. For example, described herein are mixed matrix membranes with few interfacial defects at the metal organic framework/polymer interface, mechanical rigidity, and enough metal organic framework to reach a percolation threshold—where there exists at least one continuous metal organic framework channel across the membrane cross-section. The polymer is substantially impermeable to water and ions such that when the mixed matrix membrane is used to separate ions in an aqueous solution there is no leakage through the polymer phase and thus the water and ions must travel through the metal organic framework, thereby realizing a mixed matrix membrane with metal organic framework-like selectivity. To successfully fabricate mixed matrix membranes, nonselective defects between the polymer and metal organic framework (e.g., interfacial defects) should be minimized. Interfacial defects at the metal organic polymer/polymer interface can be minimized by using a gradient addition or other appropriate mixing procedure as taught herein and using an appropriately sized metal organic framework.

Disclosed herein are mixed matrix membranes for separating a target ion from a non-target ion in a liquid medium, the mixed matrix membranes comprising: a plurality of metal organic framework particles dispersed in a continuous polymer phase wherein the mixed matrix membrane comprises from greater than 0% to 90% by weight of the plurality of metal organic framework particles relative to the mixed matrix membrane; wherein each of the plurality the metal organic framework particles comprises a channel traversing the metal organic framework particle from a first pore window to a second pore window, wherein the first pore window and the second pore window have an average pore window diameter; wherein the target ion has a target ion crystal diameter and a target ion solvated diameter in the liquid medium; wherein the non-target ion has a non-target ion crystal diameter and a non-target ion solvated diameter in the liquid medium; wherein the average pore window diameter is greater than the target ion crystal diameter and less than or equal to the target ion solvated diameter; wherein the target ion crystal diameter is smaller than the non-target ion crystal diameter and the target ion has a lower energy of solvation than the non-target ion; wherein the mixed matrix membrane has a first surface and a second surface, with an average thickness therebetween; wherein the plurality of metal organic framework particles have an average particle size, the average particle size being less than the average thickness of the mixed matrix membrane; wherein the channels of at least a portion of the plurality of metal organic framework particles form a percolation channel that traverses the average thickness of the mixed matrix membrane from the first surface to the second surface; wherein in the absence of the plurality of metal organic framework particles the continuous polymer phase is substantially less permeable to the target ion, the non-target ion, and the liquid medium than the plurality of metal organic framework particles; such that the mixed matrix membrane is permeable to at least the target ion and the liquid medium via the percolation channel. In some examples, in the absence of the plurality of metal organic framework particles, the continuous polymer phase is substantially impermeable to the target ion, the non-target ion, and the liquid medium.

As used herein, the “solvated diameter” of an ion refers to the diameter of the ion in a solvated state. For example, when the liquid medium comprises water, the solvated diameter can refer to the hydrated diameter. As used herein, the “crystal diameter” of an ion refers to the diameter of the ion in a non-solvated state. Thus, in an aqueous medium, solvated diameter refers to the hydrated diameter of the ion and crystal diameter refers to the dehydrated diameter of the ion.

The mixed matrix membranes can exhibit a selectivity for the target ion over the non-target ion of 2 or more (e.g., 5 or more, 10 or more, 15 or more, 20 or more, 25 or more, 30 or more, 35 or more, 40 or more, 45 or more, 50 or more, 60 or more, 70 or more, 80 or more, 90 or more, 100 or more, 150 or more, 200 or more, 250 or more, 300 or more, 350 or more, 400 or more, 450 or more, 500 or more, 600 or more, 700 or more, 800 or more, 900 or more, 1000 or more, 1250 or more, or 1500 or more). In some examples, the mixed matrix membranes can exhibit a selectivity for the target ion over the non-target ion of 2000 or less (e.g., 1750 or less, 1500 or less, 1250 or less, 1000 or less, 900 or less, 800 or less, 700 or less, 600 or less, 500 or less, 450 or less, 400 or less, 350 or less, 300 or less, 250 or less, 200 or less, 150 or less, 100 or less, 90 or less, 80 or less, 70 or less, 60 or less, 50 or less, 45 or less, 40 or less, 35 or less, 30 or less, 25 or less, 20 or less, 15 or less, or 10 or less). The mixed matrix membranes can exhibit a selectivity for the target ion over the non-target ion that ranges from any of the minimum values described above to any of the maximum values described above. For example, the mixed matrix membranes can exhibit a selectivity for the target ion over the non-target ion of from 2 to 2000 (e.g., from 2 to 1000, from 1000 to 2000, from 2 to 100, from 100 to 500, from 500 to 2000, from 10 to 100, or from 10 to 1000).

The liquid medium can comprise any suitable liquid medium, for example any liquid medium in which the target ion and non-target ion are soluble while the continuous polymer phase is substantially insoluble and/or impermeable. For example, the liquid medium can comprise water, tetrahydrofuran (THF), N-methyl-2-pyrrolidone (NMP), dimethylformamide (DMF), dimethyl sulfoxide (DMSO), dimethylacetamide, dichloromethane (CH₂Cl₂), ethylene glycol, ethanol, methanol, propanol, isopropanol, acetonitrile, chloroform, acetone, hexane, heptane, toluene, methyl acetate, ethyl acetate, or combinations thereof. In some examples, the liquid medium comprises water (e.g., an aqueous solution). In some examples, the liquid medium can comprise a salt solution, produced water (e.g., from mining, fracking, oil recovery), brine, or a combination thereof.

The target ion, the non-target ion, or a combination thereof can have a concentration in the liquid medium of from greater than 0 M to saturation. For example, the concentration of the target ion, the non-target ion, or a combination thereof in the liquid medium can be greater than 0 M or more (e.g., 0.001 M or more, 0.005 M or more, 0.01 M or more, 0.05 M or more, 0.1 M or more, 0.2 M or more, 0.3 M or more, 0.4 M or more, 0.5 M or more, 0.6 M or more, 0.7 M or more, 0.8 M or more, 0.9 M or more, 1 M or more, 1.5 M or more, 2 M or more, 2.5 M or more, 3 M or more, 3.5 M or more, 4 M or more, 4.5 M or more, 5 M or more, 6 M or more, 7 M or more, or 8 M or more). In some examples, the concentration of the target ion, the non-target ion, or a combination thereof in the liquid medium can be less than saturation (e.g., 100 M or less, 50 M or less, 10 M or less, 9 M or less, 8 M or less, 7 M or less, 6 M or less, 5 M or less, 4.5 M or less, 4 M or less, 3.5 M or less, 3 M or less, 2.5 M or less, 2 M or less, 1.5 M or less, 1 M or less, 0.9 M or less, 0.8 M or less, 0.7 M or less, 0.6 M or less, 0.5 M or less, 0.4 M or less, 0.3 M or less, 0.2 M or less, 0.1 M or less, 0.05 M or less, or 0.01 M or less). The concentration of the target ion, the non-target ion, or a combination thereof in the liquid medium can range from any of the minimum values described above to any of the maximum values described above. For example, the concentration of the target ion, the non-target ion, or a combination thereof in the liquid medium can be from greater than 0 M to saturation (e.g., from 0.001 M to 1000 M, from 0.001 M to 100 M, from 0.001 M to 10 M, from 0.1 M to 5 M, 0.1 M to 1 M, or from 0.1 M to 0.3 M).

The target ion and the non-target ion can comprise any suitable ions. For example, the target ion can comprise a monovalent ion and the non-target ions can comprise a divalent ion. In some examples, the monovalent ion can comprise an alkali metal cation, a halide anion, or a combination thereof. In some examples, the target ion comprises Li⁺ and the non-target ion comprises Mg²⁺, Ca²⁺, SO₄²⁻, or a combination thereof. In some examples, the target ion comprises Li⁺ and the non-target ion comprises Mg²⁺. In some examples, the target ion comprises Cl⁻ and the non-target ion comprises SO₄²⁻. In some examples, the target ion comprises F⁻ and the non-target ion comprises Cl⁻.

Methods of Making

Also disclosed herein are methods of making any of the mixed matrix membranes described herein. To successfully fabricate mixed matrix membranes, nonselective defects between the continuous polymer phase and the plurality of metal organic framework particles (e.g., interfacial defects) should be minimized. Interfacial defects at the metal organic framework particle/polymer interface can be minimized by using a gradient addition mixing procedure, alternative mixing procedures as taught herein, and/or by using appropriately sized metal organic framework particles.

The gradient mixing procedure involves two major steps: metal organic framework priming and bulk dispersion. First, the plurality of metal organic framework particles are dispersed in a solvent to form a metal organic framework solution. Then a small amount of the polymer is added to the metal organic framework solution. By adding a small amount of the polymer to the metal organic framework solution, the metal organic framework particles can be pre-coated in polymer chains in a less viscous and energetic environment (e.g., than if all of the polymer was added at once). Pre-coating the metal organic framework particles can avoid agglomeration of the metal organic framework particles during the next step, bulk dispersion. During bulk dispersion, the remainder of the polymer is added to the metal organic framework solution and the resulting solution is sonicated and stirred. If all the polymer was added to the metal organic framework solution without the initial gradient addition, the metal organic framework particles can agglomerate and form weaker dispersions. Since the metal organic framework particles were pre-coated during the priming step, they disperse well into the final metal organic framework/polymer/solvent system; the dispersions are stable over long periods of a week or more.

In an alternative mixing procedure, metal organic framework particles are mixed in a solvent, such as anhydrous tetrahydrofuran, sealed in a vial and mixed via sonication to break up and exfoliate the MOF particles. In several, for example, four or more additions, ⅛, ⅛, ¼, and ½, respectively, of dry polymer powder are added to the vial, with the vial being sealed and mixed until the solution appears homogeneous between each addition. Approximately three hours of stirring are provided between each addition. The solution can then be cast via evaporation or via non-solvent induced film deposition (NIFD) as described herein.

For example, also disclosed herein are methods of making any of the mixed matrix membranes described herein, the methods comprising: dispersing the plurality of metal organic framework particles in a first solvent, thereby forming a metal organic framework solution; dispersing a polymer in a second solvent, thereby forming a polymer solution; combining the metal organic framework solution and the polymer solution, thereby forming a mixture; and depositing the mixture, thereby forming the mixed matrix membrane. In some examples, the methods can further comprise evaporating the first solvent and/or the second solvent after depositing the mixture.

The fist solvent and the second solvent can comprise any suitable solvent. Examples of suitable solvents include, but are not limited to, tetrahydrofuran (THF), N-methyl-2-pyrrolidone (NMP), dimethylformamide (DMF), dimethyl sulfoxide (DMSO), dimethylacetamide, dichloromethane (CH₂Cl₂), ethylene glycol, ethanol, methanol, propanol, isopropanol, water, acetonitrile, chloroform, acetone, hexane, heptane, toluene, methyl acetate, ethyl acetate, and combinations thereof. In some examples, the first solvent, the second solvent, or a combination thereof can comprise tetrahydrofuran (THF), N-methyl-2-pyrrolidone (NMP), or a combination thereof. In some examples, the first solvent and the second solvent are the same.

Dispersing the metal organic framework in the first solvent and/or dispersing the polymer in the second solvent can be accomplished by mechanical agitation, for example, mechanical stirring, shaking, vortexing, sonication (e.g., bath sonication, probe sonication, ultrasonication), and the like, or combinations thereof. In some examples, the dispersing and combining steps can comprise comprising gradient addition mixing.

Depositing the mixture can comprise, for example, spin coating, drop-casting, zone casting, evaporative casting, dip coating, blade coating, spray coating, or combinations thereof. In some examples, the depositing step comprises doctor blade casting.

In some examples, after depositing the mixture the methods can further comprise evaporating the first solvent and/or the second solvent.

Also disclosed herein are methods of making the mixed matrix membranes described herein, the methods comprising: combining the plurality of metal organic framework particles with a first solvent, thereby forming a metal organic framework solution; sonicating the metal organic framework solution, thereby forming a sonicated metal organic framework solution; mixing a polymer with a second solvent, thereby forming a polymer solution; combining the sonicated metal organic framework solution and a portion of the polymer solution, thereby forming a first mixture and a remaining portion of the polymer solution; sonicating the first mixture, thereby forming a sonicated first mixture; combining the remaining portion of the polymer solution and the sonicated first mixture, thereby forming a second mixture; sonicating the second mixture, thereby forming a sonicated second mixture; depositing the sonicated second mixture, thereby forming a film; and evaporating the first solvent and/or the second solvent from the film, thereby forming the mixed matrix membrane. In some examples, the second mixture can comprise 10% or more polymer by weight (e.g., 15% or more, 20% or more, 25% or more, 30% or more, 35% or more, 40% or more, 45% or more, or 50% or more).

Alternative methods of making mixed matrix membranes are disclosed in the co-pending applications titled “Methods of Fabricating Polymer Films and Membranes,” U.S. Application Ser. No. 62/892,440, filed Aug. 27, 2019, and its corresponding PCT application, which is filed the same day as this disclosure. The methods disclosed in the co-pending applications are hereby incorporated by reference herein.

Systems and Methods of Use

Also provided herein are methods of use of any of the mixed matrix membranes described herein. For example, the mixed matrix membranes described herein can be used to separate a target ion from a non-target ion in a liquid medium (e.g., in an aqueous solution). In some examples, the mixed matrix membranes described herein can be used for mineral separation, ion separations, water purification, energy conversion, or a combination thereof. In some examples, the mixed matrix membranes described herein can be used for the selective removal of Li from a high salinity aqueous solution in a continuous process.

Also provided herein are methods comprising separating a target ion from a non-target ion in a liquid medium using a mixed matrix membrane, wherein the mixed matrix membrane comprises a plurality of metal organic framework particles dispersed in a continuous polymer phase.

Also disclosed herein are systems comprising any of the mixed matrix membranes disclosed herein and liquid medium comprising the target ion and the non-target ion, such that the target ion and the non-target ion are solvated. Also disclosed herein are systems comprising any of the mixed matrix membranes disclosed herein and an aqueous solution comprising the target ion and the non-target ion, such that the target ion and the non-target ion are hydrated. In some examples, the systems can further comprise an electrode and a voltage source, wherein the voltage source and electrode are configured to apply a potential bias to generate an electric field gradient that influences the flow of the target ion through the mixed matrix membrane. Also disclosed herein are methods of use of the systems described herein, the method comprising applying a potential bias to generate an electric field gradient that influences the flow of the target ion through the mixed matrix membrane to thereby separate the target ion from the non-target ion in the liquid medium (e.g., in the aqueous solution).

The examples below are intended to further illustrate certain aspects of the methods and compounds described herein and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods, compositions, and results. These examples are not intended to exclude equivalents and variations of the present invention, which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures, and other reaction ranges and conditions that can be used to optimize the product purity and yield obtained from the described process. Only reasonable and routine experimentation will be required to optimize such process conditions.

### Example 1

Gradient Mixing and Film Formation

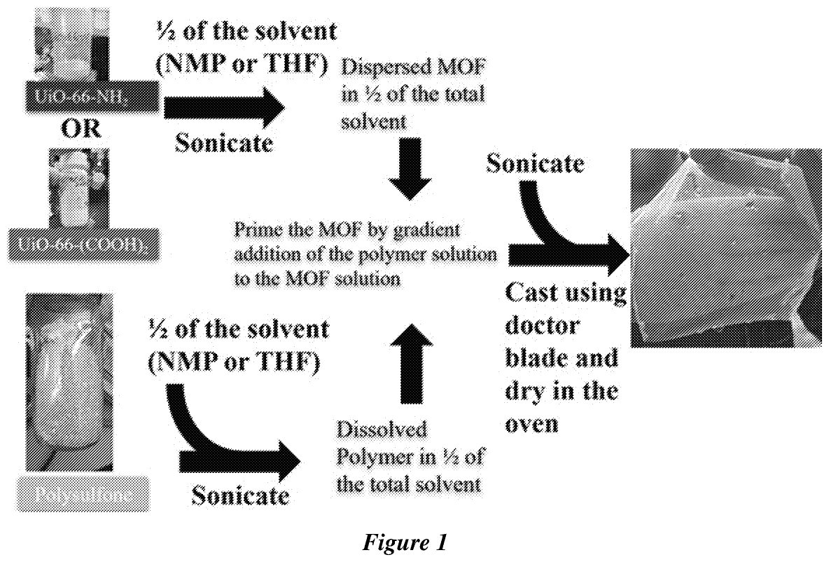

The gradient mixing method is shown schematically in FIG. 1. Metal organic framework particles were added to a solvent and labeled solution 1. Solution 1 was ultrasonicated until the metal organic framework particles were dispersed. A desired amount of polymer and solvent were mixed to make a stock polymer solution and labeled solution 2. Solution 2 was added to solution 1 in an amount equal to 20% of the final desired polymer concentration to form Solution 3. Solution 3 was then vortex mixed, followed by ultrasonication. After ultrasonication, solution 2 was added to solution 3 in an amount equal to 80% of the final desired polymer concentration to form solution 4. Solution 4 was then vortex mixed, followed by ultrasonication. Solution 4 was then cast into a film. The film was then placed into DI water for storage.

Transport Property and Selectivity Measurements

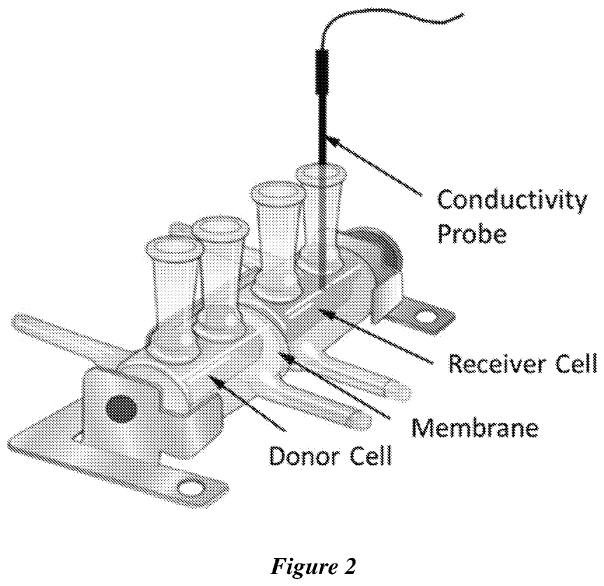

To measure the transport and selectivity properties of the films, 3 cm diameter samples of the film were cut out of the parent film. These samples were soaked in DI water for 24 hours and the DI water was changed at least 3 times over a 24 hour period to ensure any stray ions were removed from the samples. The samples were then sandwiched between the aperture of two glass Permegear diffusion cells by clamps holding the cells together (FIG. 2). The upstream cell (donor cell) was filled with 35 ml of the salt of interest in DI water, nominally either 1 molar LiCl or MgCl₂. The downstream cell (receiver cell) was filled with 35 ml of DI water. Both cells were stirred. A water jacket around the outside cavity in the Permegear cells was set to a temperature of 25° C. to ensure no temperature deviations. A conductivity probe was used to measure the conductivity of the downstream cell over time. A calibration curve for the concentration of the salt of interest versus molar concentration was run at 25° C. to convert the collected conductivity values to molar values in the downstream cell versus time. The permeability was calculated via Equation 1:

$$ln [ 1 - 2 \frac{{C}_{r} ( t )}{{C}_{d}} ] * [ \frac{- V * T}{2 A} ] = Pt \qquad ( 1 )$$

where C_{d} is the molar concentration of salt in the donor cell, V is the volume of a cell, T is the membrane thickness, A is the area available for mass transfer, t is the time, P is the permeability, and Cᵣ(t) is the molar concentration of the salt in the receiver cell calculated from the measured conductivity values through the calibration curve. The slope of t vs

$$ln [ 1 - 2 \frac{{C}_{r} ( t )}{{C}_{d}} ] * [ \frac{- V * T}{2 A} ]$$

in the pseudo-steady state is P, the salt permeability. Selectivity was calculated as the ratio of permeabilities. Between tests, the samples were removed from the cell, rinsed, and soaked in DI water for 24 hours, wherein the DI water was changed at least 3 times over the 24 hour period.

### Example I—40 wt % UiO-66-(COOH)₂ in Polysulfone Film

UiO-66-(COOH)₂ (0.5 g) was added to 4 g of N-Methyl-2-pyrrolidone and labeled solution 1. Solution 1 was ultrasonicated for 2 hours at intervals of 1 second sonication on and 5 seconds sonication off. Solution 1 was then left to stir on a stir plate overnight. Polysulfone (3 g, UDEL P-3500 LCD MB7, Solvay Specialty Polymers) was added to 7 g N-Methyl-2-pyrrolidone and labeled solution 2. Solution 2 was stirred overnight at 80° C. Solution 2 was cooled to room temperature and 0.5 g of solution 2 was added to solution 1 to form solution 3. Solution 3 was then vortex mixed for 2 minutes, then ultrasonicated for 2 hours at intervals of 1 second sonication on and 5 seconds sonication off. After ultrasonication, 2 g of solution 2 was added to solution 3 to form solution 4. Solution 4 was then vortex mixed for 2 minutes, then ultrasonicated for 2 hours at intervals of 1 second sonication on, 5 seconds sonication off.

Solution 4, containing a total of 2.5 grams of solution 2, was then poured into a glass dish. This glass dish was set onto a leveled plate in an oven, to ensure an even coating of solution 4 on the glass dish and heated at 100° C. under vacuum for 12 hours. Afterwards, the glass dish was removed from the oven and the 40 wt % UiO-66-(COOH)₂ in polysulfone film was slowly cooled to room temperature. The dish was filled with deionized (DI) water to release the film from the glass dish. The film was then placed into DI water for storage.

### Example II—20 wt % UiO-66-(COOH)₂ in Polysulfone Film

UiO-66-(COOH)₂ (0.5 g) was added to 4 g of N-Methyl-2-pyrrolidone and labeled solution 1. Solution 1 was ultrasonicated for 2 hours at intervals of 1 second sonication on, 5 seconds sonication off. Solution 1 was then left to stir on a stir plate overnight. Polysulfone (3 g, UDEL P-3500 LCD MB7, Solvay Specialty Chemicals) was added to 7 g N-Methyl-2-pyrrolidone and labeled solution 2. Solution 2 was stirred overnight at 80° C. Solution 2 was cooled to room temperature and 1.33 g of solution 2 was added to solution 1 to form solution 3. Solution 3 was then vortex mixed for 2 minutes, then ultrasonicated for 2 hours at intervals of 1 second sonication on, 5 seconds sonication off. After ultrasonication, 5.33 g of solution 2 was added to solution 3 to form solution 4. Solution 4 was then vortex mixed for 2 minutes, then ultrasonicated for 2 hours at intervals of 1 second sonication on, 5 seconds sonication off.

Solution 4, containing 6.66 grams of solution 2, was then poured into a glass dish. This glass dish was set onto a leveled plate in an oven, to ensure an even coating of solution 4 on the glass dish and heated at 100° C. under vacuum for 12 hours. Afterwards, the glass dish was removed from the oven and the 20 wt % UiO-66-(COOH)₂ in polysulfone film was slowly cooled to room temperature. The dish was filled with deionized (DI) water to release the film from the glass dish. The film was then placed into DI water for storage.

### Example III—40 wt % UiO-66-NH₂ in Polysulfone Film

UiO-66-NH₂ (0.5 g) was added to 4 g of N-Methyl-2-pyrrolidone and labeled solution 1. Solution 1 was ultrasonicated for 2 hours at intervals of 1 second sonication on, 5 seconds sonication off. Solution 1 was then left to stir on a stir plate overnight. Polysulfone (3 g, UDEL P-3500 LCD MB7, Solvay Specialty Chemicals) was added to 7 g N-Methyl-2-pyrrolidone and labeled solution 2. Solution 2 was stirred overnight at 80° C. Solution 2 was cooled to room temperature and 0.5 g of solution 2 was added to solution 1 to form solution 3. Solution 3 was then vortex mixed for 2 minutes, then ultrasonicated for 2 hours at intervals of 1 second sonication on, 5 seconds sonication off. After ultrasonication, 2 g of solution 2 was added to solution 3 to form solution 4. Solution 4 was then vortex mixed for 2 minutes, then ultrasonicated for 2 hours at intervals of 1 second sonication on, 5 seconds sonication off.

Solution 4, containing 2.5 grams of solution 2, was then poured into a glass dish. This glass dish was set onto a leveled plate in an oven, to ensure an even coating of solution 4 on the glass dish and heated at 100° C. under vacuum for 12 hours. Afterwards, the glass dish was removed from the oven and the 40 wt % UiO-66-NH₂ in polysulfone film was slowly cooled to room temperature. The dish was filled with deionized (DI) water to release the film from the glass dish. The film was then placed into DI water for storage.

### Example IV—40 wt % UiO-66-(COOH)₂ in Torlon Film

UiO-66-UiO-66-(COOH)₂ (0.5 g) was added to 4 g of N-Methyl-2-pyrrolidone and labeled solution 1. Solution 1 was ultrasonicated for 2 hours at intervals of 1 second sonication on, 5 seconds sonication off. Solution 1 was then left to stir on a stir plate overnight. Torlon (3 g, Torlon 4000T-MV poly(amideimide), Solvay) was added to 7 g N-Methyl-2-pyrrolidone and labeled solution 2. Solution 2 was stirred overnight at 80° C. Solution 2 was cooled to room temperature and 0.5 g of solution 2 was added to solution 1 to form solution 3. Solution 3 was then vortex mixed for 2 minutes, then ultrasonicated for 2 hours at intervals of 1 second sonication on, 5 seconds sonication off. After ultrasonication, 2 g of solution 2 was added to solution 3 to form solution 4. Solution 4 was then vortex mixed for 2 minutes, then ultrasonicated for 2 hours at intervals of 1 second sonication on, 5 seconds sonication off.

Solution 4, containing 2.5 grams of solution 2, was then poured into a glass dish. This glass dish was set onto a leveled plate in an oven, to ensure an even coating of solution 4 on the glass dish and heated at 100° C. under vacuum for 12 hours. Afterwards, the glass dish was removed from the oven and the 40 wt % UiO-66-(COOH)₂ in Torlon film was slowly cooled to room temperature. The dish was filled with deionized (DI) water to release the film from the glass dish. The film was then placed into DI water for storage.

### Example V

The same procedure was followed as in Example I through Example III, but tetrahydrofuran was used in place of N-Methyl-2-pyrrolidone. Furthermore, instead of curing in an oven at 100° C. under vacuum, the solution was evaporated in a fume hood overnight.

### Example VI—40 wt % UiO-66-(COOH)₂ in Polyethersulfone Film

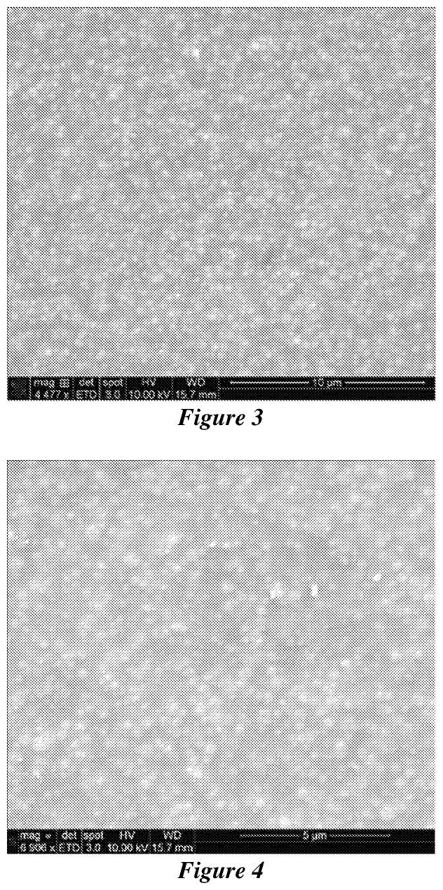

The same procedure was followed as in Example I, but polyethersulfone was used in place of polysulfone. This resulted in a 40 wt % UiO-66-(COOH)₂ in polyethersulfone film. An SEM image of the mixed matrix membrane comprising 40 wt % UiO-66-(COOH)₂ in polyethersulfone is shown in FIG. 3.

### Example VII—20 wt % UiO-66-(COOH)₂ in Polyethersulfone Film

The same procedure was followed as in Example II, but polyethersulfone was used in place of polysulfone. This resulted in a 20 wt % UiO-66-(COOH)₂ in polyethersulfone film.

### Example VII—40 wt % UiO-66-(COOH)₂ in Polyphenylsulfone Film

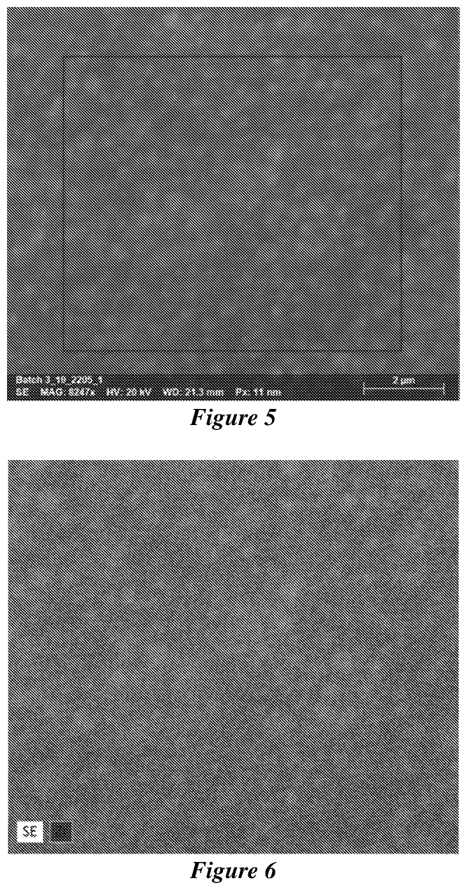

The same procedure was followed as in Example I, but polyphenylsulfone was used in place of polysulfone. This resulted in a 40 wt % UiO-66-(COOH)₂ in polyphenylsulfone film. SEM images of the 40 wt % UiO-66-(COOH)₂ in polyphenylsulfone film are shown in FIG. 4 and FIG. 5. EDX mapping of the section of the sample designated by the rectangle in FIG. 5 indicated that the zirconium was well dispersed throughout the structure (FIG. 6), indicating the metal organic framework particles were well dispersed throughout the mixed matrix membrane.

### Example IX—20 wt % UiO-66-(COOH)₂ in Polyphenylsulfone Film

The same procedure was followed as in Example II, but polyphenylsulfone was used in place of polysulfone. This resulted in a 20 wt % UiO-66-(COOH)₂ in polyphenylsulfone film.

### Example X

The same procedure as above was used to make mixed matrix membranes, but where Matrimid (Matrimid 5218) was used in place of polysulfone as the polymer.

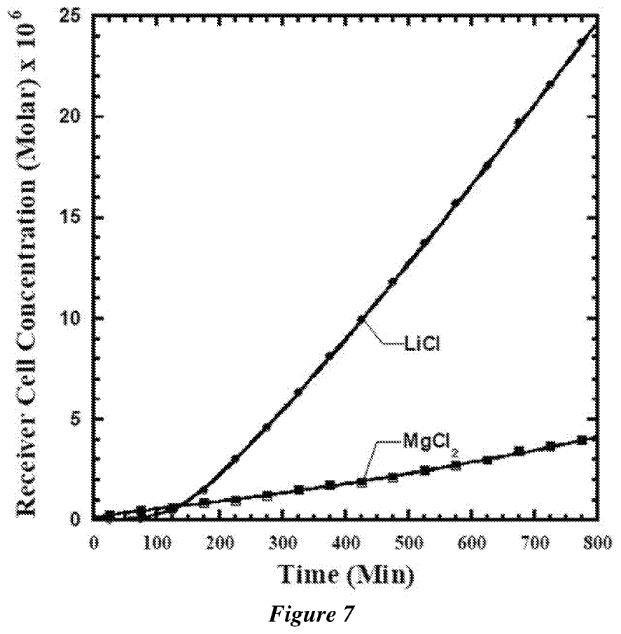

Table 3 is a summary of the various mixed matrix membranes made using the gradient mixing procedure. The transport and selectivity properties of the various mixed matrix membranes were tested using the general procedure described above. The transport and selectivity results for Example I are shown in FIG. 7.

TABLE 3
Summary of various mixed matrix membranes.

| | | Weight Loading of |
|---|---|---|
| MOF | Polymer | MOF in Polymer |
| UiO-66-(COOH)₂ | Polysulfone | 20% |
| UiO-66-(COOH)₂ | Polysulfone | 40% |
| UiO-66-NH₂ | Polysulfone | 40% |
| UiO-66-(COOH)₂ | Matrimid | 20% |
| UiO-66-NH₂ | Matrimid | 20% |
| UiO-66-NH₂ | Matrimid | 50% |
| UiO-66-(COOH)₂ | Torlon | 40% |
| UiO-66-(COOH)₂ | Torlon | 60% |
| UiO-66-(COOH)₂ | Polyethersulfone | 20% |
| UiO-66-(COOH)₂ | Polyethersulfone | 40% |
| UiO-66-(COOH)₂ | Polyphenylsulfone | 20% |
| UiO-66-(COOH)₂ | Polyphenylsulfone | 40% |

The permeability and water uptake results for the mixed matrix membranes of Example I (40 wt % UiO-66-(COOH)₂ in Polysulfone film) and Example 11(20 wt % UiO-66-(COOH)₂ in Polysulfone film) relative to a control membrane (Polysulfone film without any UiO-66-(COOH)₂) are summarized in Table 4. The results in Table 4 indicate that the permeability and water update of the mixed matrix membranes increased as the weight loading of UiO-66-(COOH)₂ increased.

TABLE 4
Permeability and water uptake results for membranes prepared
from polysulfone with varying amounts of UiO-66-(COOH)₂.

| Weight Percent of UiO-66- | LiCl Permeability | MgCl₂ Permeability | Water Uptake |
|---|---|---|---|
| (COOH)₂ in polysulfone | (cm²/s) | (cm²/s) | (g Water/g MMM) |
| 0 | Not Detected | Not Detected | 0.003 |
| 20 | 1.47 × 10⁻¹² | Not Detected | 0.06 |
| 40 | 2.55 × 10⁻¹¹ | 2.02 × 10⁻¹² | 0.12 |

The permeability and selectivity results for the mixed matrix membranes of Example I (40 wt % UiO-66-(COOH)₂ in Polysulfone film), Example III (40 wt % UiO-66-NH₂ in Polysulfone film), Example IV (40 wt % UiO-66-(COOH)₂ in Torlon film), Example IX (20 wt % UiO-66-(COOH)₂ in polyphenylsulfone film), and Example VIII (40 wt % UiO-66-(COOH)₂ in polyphenylsulfone film) are summarized in Table 5.

TABLE 5
Permeability and Li/Mg selectivity of various mixed matrix membranes.

| | | LiCl | MgCl₂ | |
|---|---|---|---|---|
| | Salt | Permeability | Permeability | Li⁺/Mg²⁺ |
| Membrane | Concentration | (cm²/s) | (cm²/s) | Selectivity |
| 40 wt. % of UiO-66- | 1 molar | 2.55 × 10⁻¹¹ | 2.02 × 10⁻¹² | 13 |
| (COOH)₂ | | | | |
| in polysulfone | | | | |
| 40 wt. % of UiO-66-NH₂ | 1 molar | 6.10 × 10⁻¹¹ | 1.38 × 10⁻¹² | 44 |
| in polysulfone | | | | |
| 40 wt. % of UiO-66- | 1 molar | 3.18 × 10⁻¹¹ | Not Detected | >100 |
| (COOH)₂ | | | | |
| in Torlon | | | | |
| 20 wt. % of UiO-66- | 1 molar | Not Detected | Not Detected | N/A |
| (COOH)₂ | | | | |
| in polyphenylsulfone | | | | |
| 40 wt. % of UiO-66- | 1 molar | 1.67 × 10⁻¹² | Not Detected | >100 |
| (COOH)₂ | | | | |
| in polyphenylsulfone | | | | |

### Example 2

The metal organic framework (MOF) based mixed matrix membranes (MMMs) described herein can selectively separate monovalent ions (such as Li, K, Na, F, and Cl) from complex mixtures including divalent ions (such as Ca, Mg, SO₃, and CO₃) in high salinity environments. The mixed matrix membranes described herein harness the selectivity and permeability of metal organic frameworks in a scalable and durable membrane platform for use in selectively separating ions in aqueous solutions. The mixed matrix membranes described herein can transport, separate, and/or size sieve ions based on their dehydrated radii, affinity for specific metal organic framework chemistries, and energy of hydration.

The MMMs comprise a polymer (e.g., cellulose acetate or polysulfone) and a metal organic framework (e.g., UiO-66-(COOH)₂, UiO-66-NH₂). The MOF is a nanoparticle formed of metal nodes (e.g., Zr in the case of UiO-66 based metal organic frameworks) connected by organic linkers. This cage-like structure has angstrom sized apertures. The mixed matrix membranes include metal organic frameworks that have apertures that are larger than the crystal radii of ions in solution, but smaller than their hydrated radii. Therefore, the ions of smaller crystal radii, or lower energy of hydration, elute first through the metal organic framework structure and thus the mixed matrix membrane.

The metal organic frameworks may be dispersed into a hydrophobic polymer material that is impermeable to water and ions relative to the metal organic frameworks. At a high weight loading of metal organic frameworks in the polymer (e.g., polysulfone, PSf, or cellulose acetate), the metal organic frameworks form random channels that allow for selectivity towards the ions of smaller crystal radii (e.g., Li permeates before Mg). The polymer acts as a ‘glue’ that provides the mixed matrix membrane with structural integrity, processability, and scalability. Increasing the weight loading of metal organic framework in the polymer increases the number of interconnected metal organic framework networks from one side of the membrane to the other.

The mixed matrix membranes offer selectivity of monovalents (e.g., Li) over divalents (e.g., Mg) in aqueous environments, even at high concentrations (e.g., 0.1-1 M) and/or in high salinity environments. Therefore, the mixed matrix membranes are attractive for the selective removal of Li from high salinity sources containing high concentrations of Mg. Further, the mixed matrix membranes can operate in a continuous process. Current technologies for continuous monovalent/divalent separations such as nanofiltration fail in high salinity environments because they rely on electrical repulsion to reject the higher charged divalent ions. Nanofiltration does not show selectivity in high salinity environments because the ionic strength of these solutions effectively screens the divalent ions from ever experiencing the repulsion. Furthermore, the high salinity of these solutions leads to the inability to use reverse osmosis type membranes due to the astronomically high osmotic pressures that would need to be overcome to extract water.

Other batch technologies exist that are selective for Li (sorbents), but they generally foul in solutions containing many types of ions and require rejuvenation. Furthermore, most sorbents are also selective for Mg with the Li, leading to the same crystallization problems as current processes. These are also batch processes and requires precise schedules, wash cycles (acid and fresh water use), and replacement to operate.

The mixed matrix membranes can improve the extraction of Li from brine solutions around the world. Lithium mining companies focused on brine-based operations are plagued by high Mg/Li ratios that complicate the purification of Li from these brines. Current known brine sources of Li can contain upwards of 20× more Mg ions than Li ions. This complicates the Li extraction process, since Mg salts will precipitate with the Li salts using conventional methods, leading to unacceptable purities. Current processes can lose upwards of 70% of the lithium in their brines in the process of removing the Mg. The mixed matrix membranes described herein can substantially speed up the current evaporative processes and reduce the 70% loss of Li, allowing lithium suppliers to meet the astronomical demand for lithium. This would also severely reduce the required time for the brine to sit in the evaporation ponds as the need for Mg removal this way would decrease.

Further, the mixed matrix membranes can selectively remove Li and other monovalents from solutions containing Mg and other divalents, effectively acting as water softeners and producing a Mg/divalent free product stream.

The metal organic frameworks used in these membranes are also selective for ions such as F⁻ over Cl⁻ and other monovalent and divalent anions (sulfate). This could be used as an economic option for removing harmful F⁻ ions from contaminated groundwater sources. Furthermore, nitrate removal from groundwater (farmland runoff) could be possible with these MMMs, reducing the dead zones created when nitrates cause algae blooms. Additionally, these membranes are effectively water softeners and could be used to remove foulants such as Ca and carbonate to greatly improve the lifetimes of pipe networks, heat exchangers, etc.

Increasing the weight loading of metal organic framework in the polymer increases the number of interconnected metal organic framework networks from one side of the membrane to the other, and can increase the speed of the separation. The speed of the above separations can also be increased by applying a voltage to help drive the ions across the membrane.

### Example 3

The transport and separation of resource components, minerals, and ions for water purification and resource recovery using mixed matrix membranes are described herein. The mixed matrix membranes comprising a polymer and metal organic framework (MOF) dispersed therein were prepared in this Example through gradient addition mixing, doctor blade casting, and evaporation. The mixed matrix membranes exhibited synergistic properties of the parent metal organic framework and polymer. The polymer is relatively impermeable when compared to the metal organic framework.

Polysulfone is a polymer that is mechanically stable. Casting polysulfone to form films or membranes is scalable. However, polysulfone exhibits little to no salt and water transport, and is not ion selective.

On the other hand, UiO-66-(COOH)₂ (FIG. 8) exhibits monovalent ion selectivity (e.g., a Li⁺/Mg²⁺ selectivity ranging from 200 to 1500, and a Li⁺/Ca²⁺ selectivity of 500) and is water stable. The fabrication of UiO-66-(COOH)₂ is scalable. However, UiO-66-(COOH)₂ is a powder (FIG. 8) and thus difficult to process and mechanically unstable. A platform is needed to deploy the UiO-66-(COOH)₂.

The mixed matrix membranes disclosed herein use a polymer as a platform for deploying metal organic frameworks. Mixtures of polymers and metal organic frameworks can gain the advantages of both while minimizing or avoiding their disadvantages.

The method for fabricating a mixed matrix membrane comprising a metal organic framework and polymer where the metal organic framework is UiO-66-NH₂ and/or UiO-66-(COOH)₂ and the polymer is polysulfone is shown schematically in FIG. 1 and described below.

Solvent (NMP or THF) was split into two equal parts (solution 1 and solution 2). The metal organic framework was added to solution 1 and sonicated, to form a sonicated solution 1. The polymer was dissolved in solution 2 and sonicated, to form a sonicated solution 2. A portion (20%) of sonicated solution 2 was added to sonicated solution 1, and the mixture was sonicated to form a sonicated first mixture. The remainder of sonicated solution 2 was added to the sonicated first mixture and sonicated for form solution 3. Solution 3 is ideally at least 10% polymer by weight. Solution 3 was then further mixed and sonicated. Solution 3 was then drawn down (“cast”) to a set height as a viscous film using a doctor blade. The viscous film was then placed in an oven at a set temperature and pressure to evaporate the solvent to form the mixed matrix membrane. The mixed matrix membrane was then quenched into fresh water.

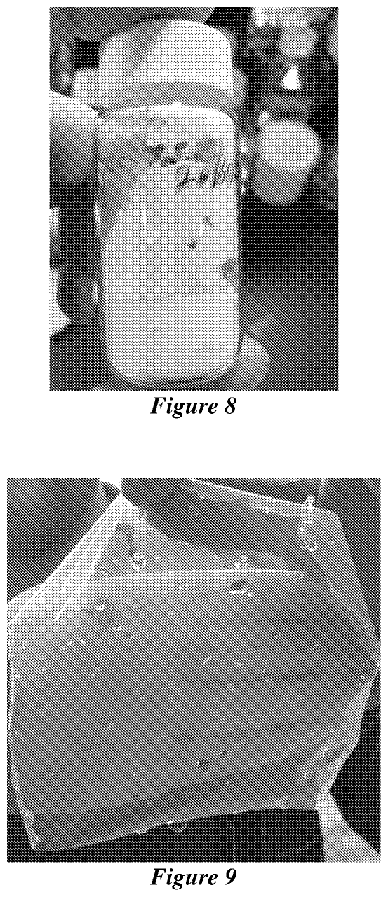

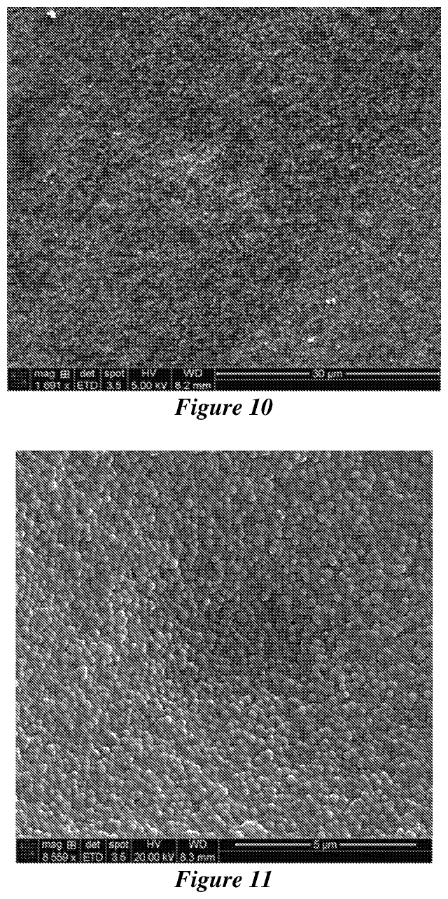

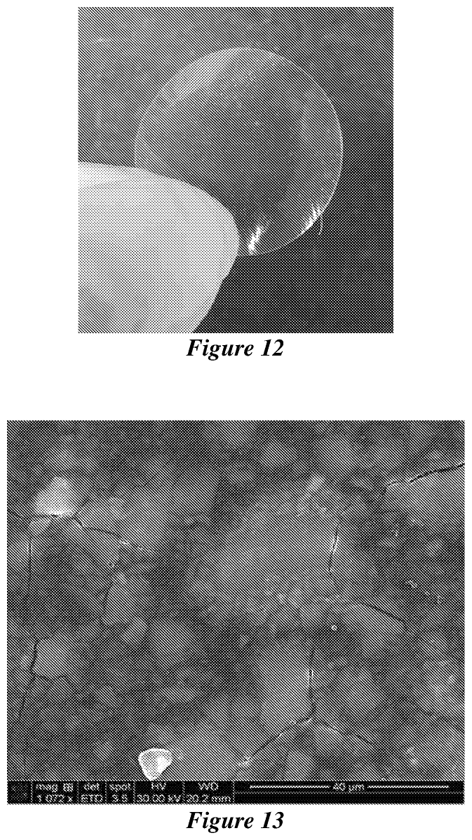

A photograph of a 25 micrometer thick mixed matrix membrane comprising 40 wt % UiO-66-(COOH)₂ is shown in FIG. 9 with a corresponding scanning electron microscopy image in FIG. 10 and FIG. 11. The mixed matrix membrane was clear and had well dispersed particles (FIG. 9, FIG. 10, and FIG. 11).

A photograph of a 16 micrometer thick mixed matrix membrane comprising 20 wt % UiO-66-(COOH)₂ is shown in FIG. 12 with a corresponding scanning electron microscopy image in FIG. 13. The mixed matrix membrane had visible particles and defect lines (FIG. 12 and FIG. 13).

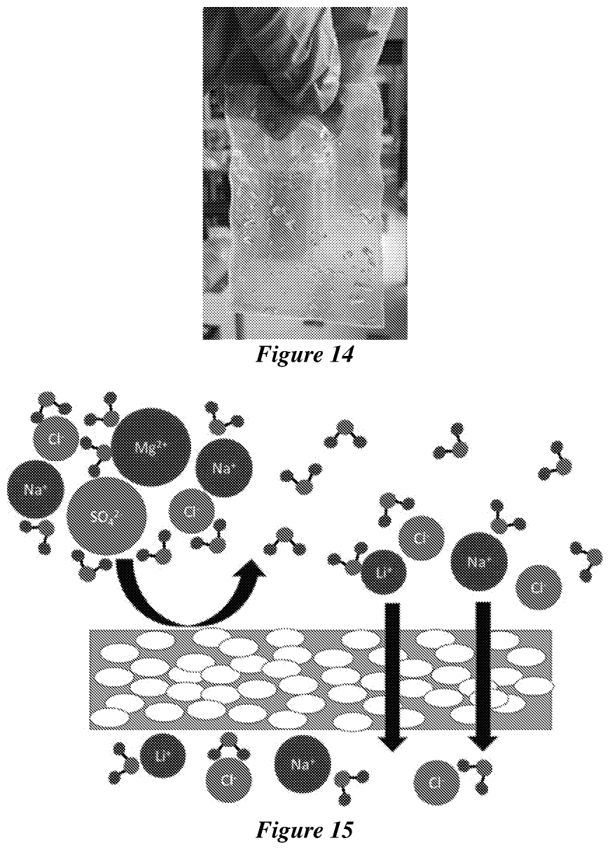

A photograph of a 16 micrometer thick mixed matrix membrane comprising 40 wt % UiO-66-(COOH)₂ is shown in FIG. 14.

A mixed matrix membrane prepared from polysulfone and UiO-66-NH₂ and/or UiO-66-(COOH)₂ exhibited selectivity of Li⁺ over Mg²⁺ and Cl⁻ over SO₄²⁻, which can be attributed to the metal organic framework, along which scalability and mechanical integrity, which can be attributed to the polymer. The mechanism of the separation is a size sieve and, unlike nanofiltration, can operate at high concentrations. A schematic of the separation is shown in FIG. 15.

Wide-angle X-Ray Scattering (WAXS) can be used to confirm metal organic framework structure incorporation in the mixed matrix membranes. Fourier Transform Infrared (FTIR) spectroscopy can be used to confirm polymer stability and the presence of functional groups from the metal organic framework after fabrication of the mixed matrix membrane. Small-angle X-Ray Scattering (SAXS) can be used to investigate the domain spacing of metal organic framework/polymer. Energy Dispersive X-Ray (EDX) spectroscopy can be used to visually investigate the metal organic framework (Zr) dispersion through the polymer matrix (cross section and top down). Scanning electron microscopy (SEM), including cross-sectional SEM, can also be used to investigate the mixed matrix membranes.

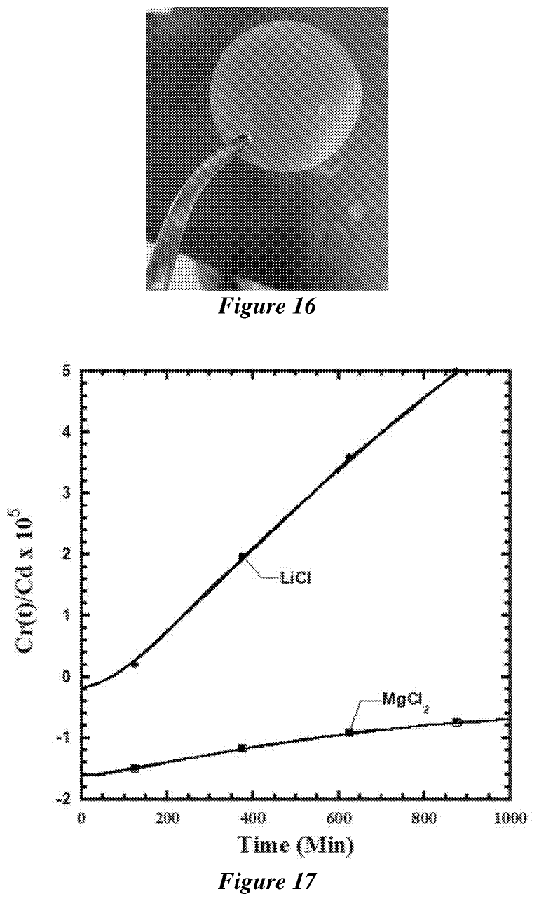

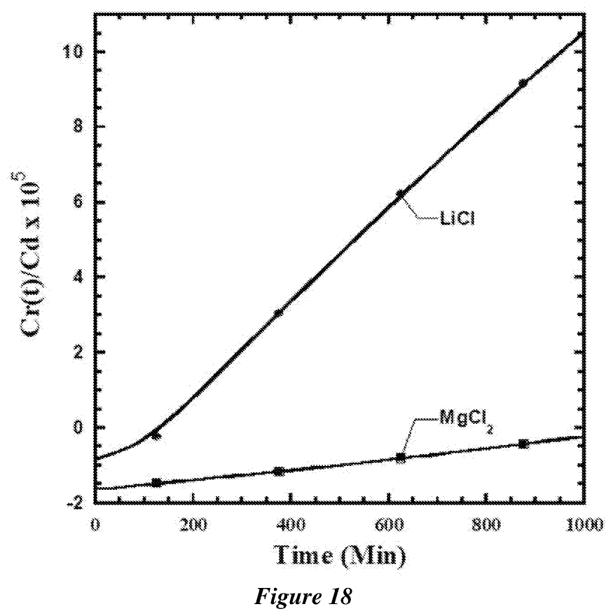

Transport experiments were performed on a 30 micrometer thick mixed matrix membrane comprising 40 wt % UiO-66-(COOH)₂ in polysulfone (FIG. 16). Tests were run using LiCl and MgCl₂, both at 0.3 M and run independently of each other (i.e. tests are run on a single salt at a time). Tests were run starting with different salt pairs (e.g., LiCl first and MgCl₂ second vs. MgCl₂ first and LiCl second), to ensure selectivity was genuine. The results as mass (normalized to donor cell concentration) versus time (0.3 M single salts) are shown in FIG. 17, where LiCl was tested before MgCl₂, and FIG. 18, where MgCl₂ was tested before LiCl.

Similar transport tests were performed on membranes prepared from polysulfone with varying amounts of UiO-66-(COOH)₂; the results are summarized in Table 6 below.

TABLE 6
Results of transport experiments on membranes prepared from
polysulfone with varying amounts of UiO-66-(COOH)₂.

| Weight Loading | P_{LiCl} | P_{MgCl2} | |
|---|---|---|---|
| (% by mass) | (cm²/s) | (cm²/s) | S_{Li+/Mg2+} |
| 0 | ND | ND | ND |
| 20 | 1.79 × 10⁻¹² | ND | >10 |
| 40 | 2.16 × 10⁻¹¹ | ND | >10 |

The results from multiple tests in Table 6 were consistent: permeabilities of MgCl₂ were below detection limits of the experiment (e.g., very little passes through). The tested membranes exhibiting selectivity of Li⁺ over Mg²⁺. An approximation of the selectivity is:

$${S}_{{Li}^{+}} \text{/} M {g}^{2 +} ≅ \frac{{P}_{LiCl}}{{P}_{M g C {l}_{2}}}$$

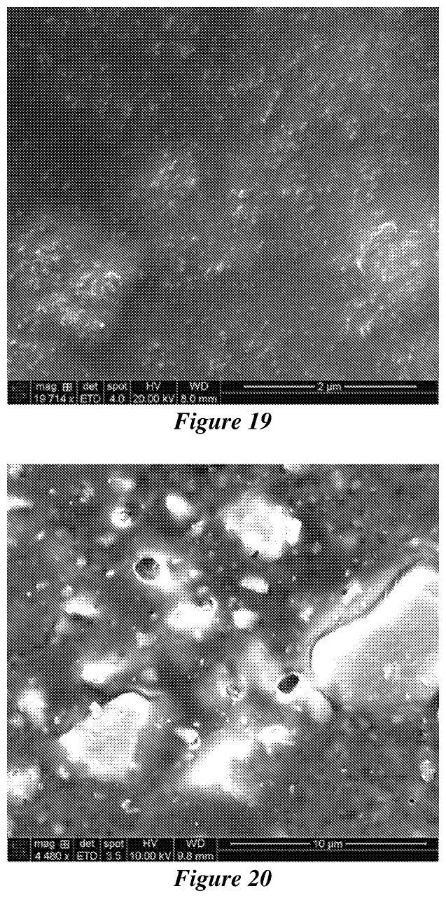

Tests were also performed to investigate the impact of the average particle size of the metal organic framework on the properties of the mixed matrix membranes. Adhesion between the metal organic framework and polymer is important for the formation of a defect free mixed matrix membrane. Scanning electron microscopy (SEM) images of mixed matrix membranes prepared using small UiO-66-(COOH)₂ particles (˜100 nm) embedded in polysulfone and large UiO-66-(COOH)₂ particles (˜10 μm) embedded in polysulfone are shown in FIG. 19 and FIG. 20, respectively. Metal organic framework particles having an average size that is less than the thickness of the mixed matrix membrane can form an integrally skinned mixed matrix membrane. Metal organic framework particles less than 1 micron in diameter can form defect free metal organic framework and polymer interfaces.

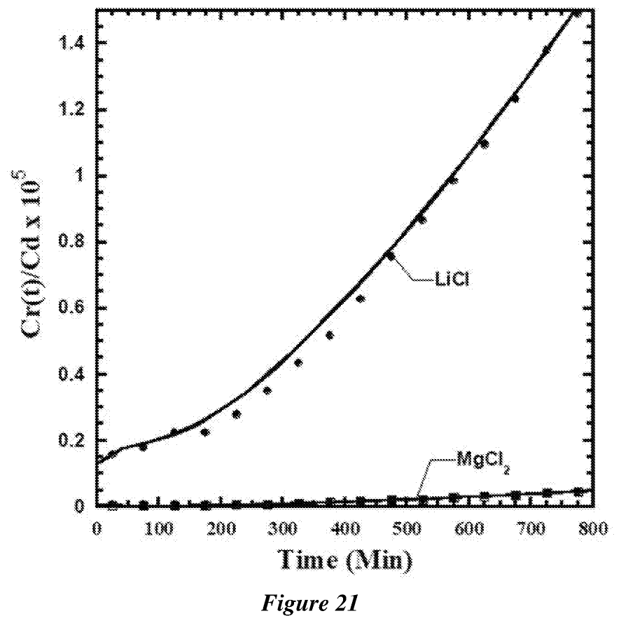

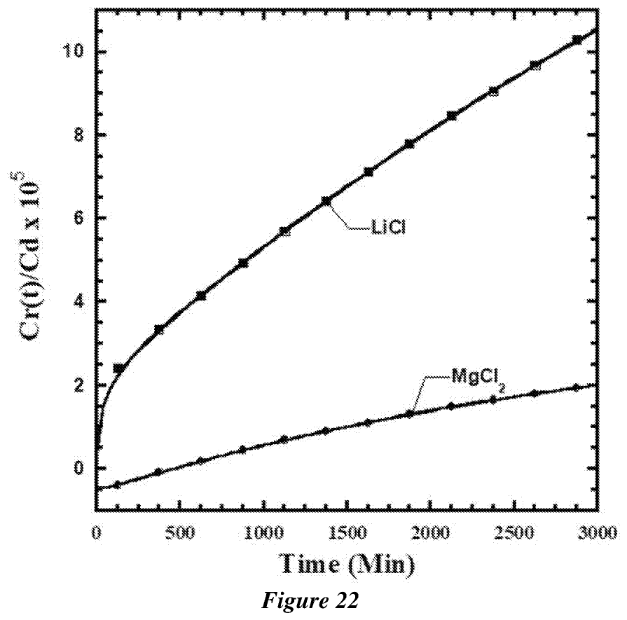

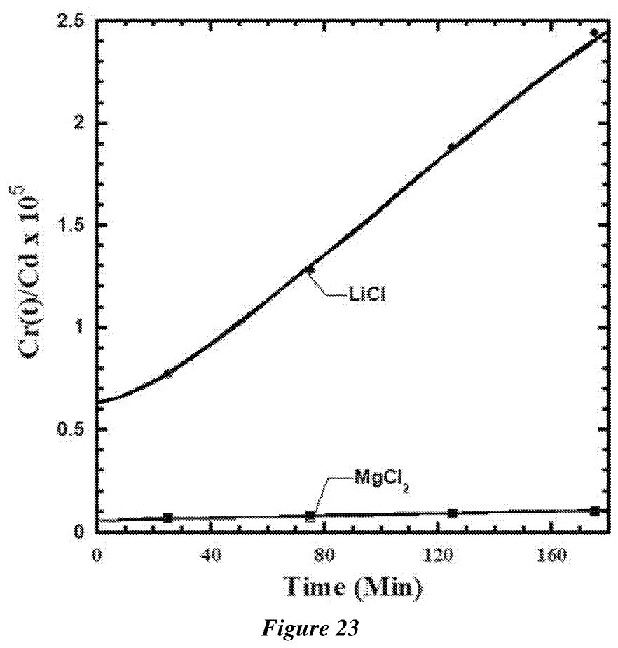

Additional tests were run on a mixed matrix membrane comprising 40 wt % UiO-66-(COOH)₂ in polysulfone and a mixed matrix membrane comprising 40 wt % UiO-66-NH₂ in polysulfone, with a pure polysulfone membrane used as a control. The mixed matrix membrane comprising 40 wt % UiO-66-(COOH)₂ in polysulfone was tested using 1 M solutions of MgCl₂ and LiCl. The results are shown in FIG. 21 and FIG. 22. The mixed matrix membrane comprising 40 wt % UiO-66-NH₂ in polysulfone was tested using 0.3 M solutions; the results are shown in FIG. 23. The results are summarized in Table 7.

TABLE 7
Results of transport experiments on various
membranes at 1 molar salt concentration.

| MOF and Weight Loading | P_{LiCl} | P_{MgCl2} | |
|---|---|---|---|
| (% by mass) | (cm²/s) | (cm²/s) | S_{Li+/Mg2+} |
| No MOF, 0% | ND | ND | ND |
| UiO-66-(COOH)₂, 40% | 3.94 × 10⁻¹¹ | 8.81 × 10⁻¹³ | >45 |
| UiO-66-(COOH)₂, 40% | 2.00 × 10⁻¹¹ | 3.23 × 10⁻¹² | >6 |
| UiO-66-NH₂, 40% | 6.10 × 10⁻¹¹ | 1.38 × 10⁻¹² | >44 |

### Example 4

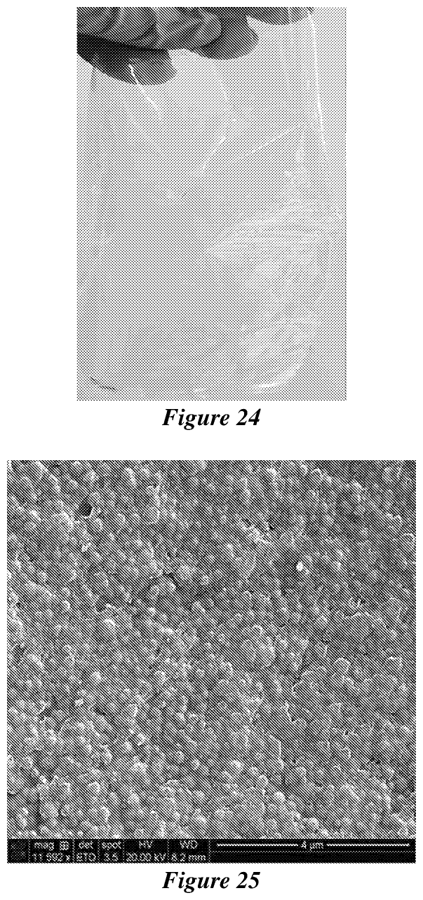

Mixed matrix membranes were prepared comprising 40 wt % UiO-66(COOH)₂ in Torlon and 40 wt % UiO-66(COOH)₂ in polysulfone to investigate the effect of the polymer on the mixed matrix membrane. A photograph and SEM image of the mixed matrix membrane comprising 40 wt % UiO-66(COOH)₂ in Torlon are shown in FIG. 24 and FIG. 25, respectively. A photograph and SEM images of the mixed matrix membrane comprising 40 wt % UiO-66(COOH)₂ in polysulfone are shown in FIG. 9, FIG. 10, and FIG. 11, respectively.

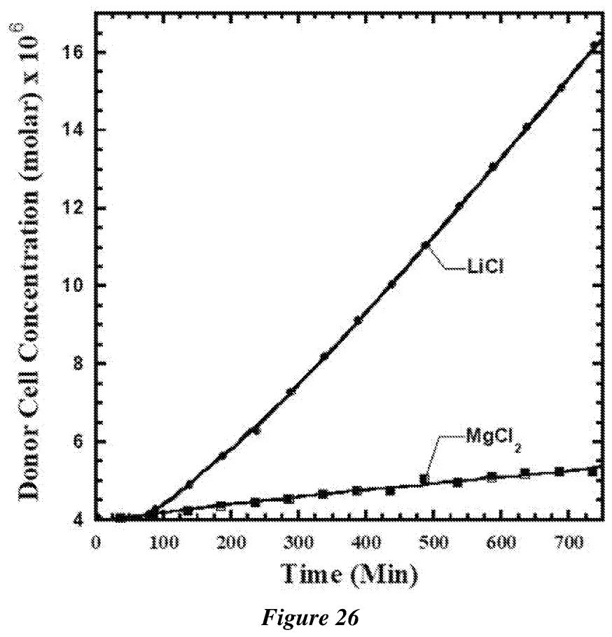

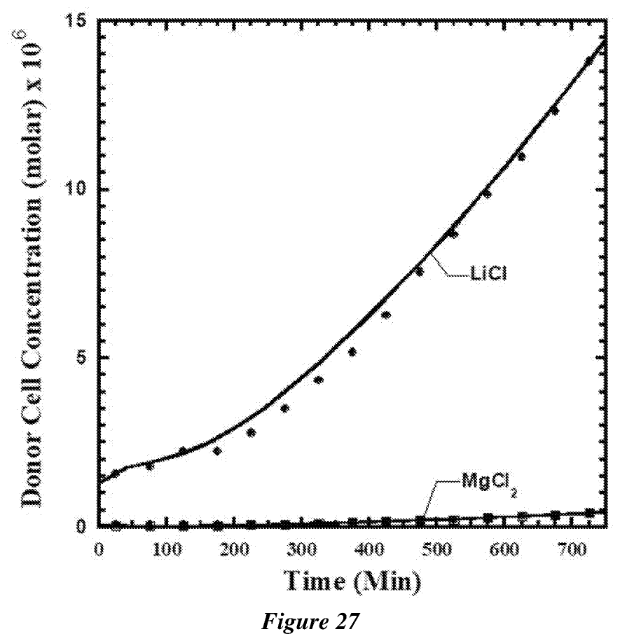

The permeability of the mixed matrix membranes comprising 40 wt % UiO-66(COOH)₂ in Torlon and 40 wt % UiO-66(COOH)₂ in polysulfone were tested. The results for single salt permeability tests at 1 Molar of each salt of MgCl₂ and LiCl through the mixed matrix membranes comprising 40 wt % UiO-66-(COOH)₂ in Torlon and 40 wt % UiO-66-(COOH)₂ in polysulfone are shown in FIG. 26 and FIG. 27, respectively. The results of the permeability tests are summarized in Table 8 below.

TABLE 8
Results of permeability experiments on various membranes.

| MOF and Weight Loading | P_{LiCl} | P_{MgCl2} | |
|---|---|---|---|
| (% by mass) | (cm²/s) | (cm²/s) | S_{Li+/Mg2+} |
| No MOF, 0% | ND | ND | ND |
| UiO-66-(COOH)₂, | 3.94 × 10⁻¹¹ | 8.81 × 10⁻¹³ | >45 |
| Polysulfone, 40% | | | |
| UiO-66-(COOH)₂, | 2.00 × 10⁻¹¹ | ND | >45 |
| Torlon, 40% | | | |

### Example 5

Mixed matrix membranes were prepared comprising poly(ethylene glycol) diacrylate (PEGDA) with UiO-66-(COOH)₂ MOF. Poly(ethylene glycol) diacrylate (PEGDA) liquid (Mn 700 Da) was measured and mixed in a mass ratio of 6:4 with UiO-66-(COOH)₂ MOF. The polymer solution was mixed via stirring followed by sonication in a bath sonicator for 30 minutes. 1-hydrocyclohexyl phenyl ketone (HCPK) was used as an initiator to crosslink the polymer. 0.01% by mass, relative to the PEGDA, of HCPK was added to the mixture and stirred for 30 minutes. The mixture was then covered with aluminum foil to prevent light from prematurely initiating the polymerization reaction. Finally, ˜1 mL of the solution was deposited onto a quartz glass plate and a cover quartz glass plate was placed atop the solution with spacers of known thickness (96 microns) separating the plates.

The solution was reacted in a UV crosslinking oven (Fisher Scientific UV chamber model FB-UVXL-1000) for 90 seconds with 312 nm wavelength UV light at 3.0 mW/cm². After reacting, the PEGDA formed a crosslinked film which was removed and immersed in water for testing. A similar film containing no MOF was synthesized as well.

After fabrication, 3 ˜2 cm diameter punches of each film (MOF and no MOF) were taken and their selectivity determined by comparing the salt permeance for magnesium and lithium chloride. In a typical experiment, a membrane sample is loaded into a permeation test cell (Permegear), using 35 ml of 1.0 M salt in the donor cell and 35 ml of DI water in the receptor cell. The permeation of salt across the membrane is monitored continuously in the receptor cell via a conductivity probe calibrated against known concentrations of the desired salt. The selectivity is calculated by dividing the steady-state permeation rate of lithium chloride via the steady-state permeation rate of magnesium chloride.

In both cases (MOF and no MOF), both films exhibited an average Li/Mg selectivity of ˜2, indicating that the presence of MOF in the PEGDA polymer film did not enhance selectivity.

### Example 6

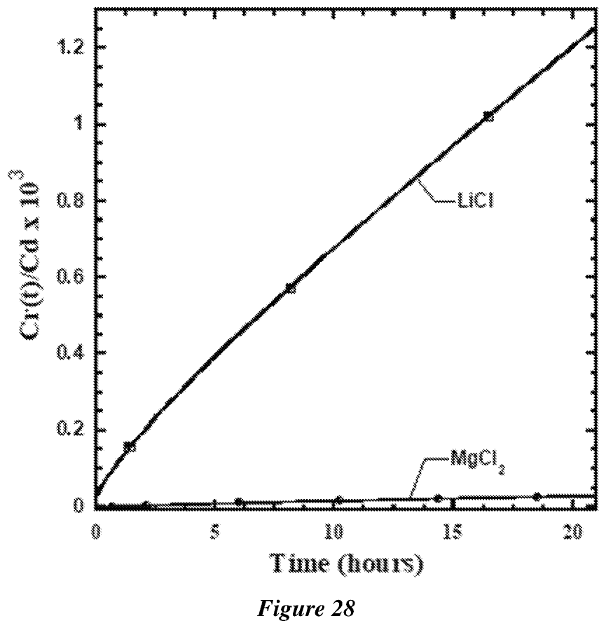

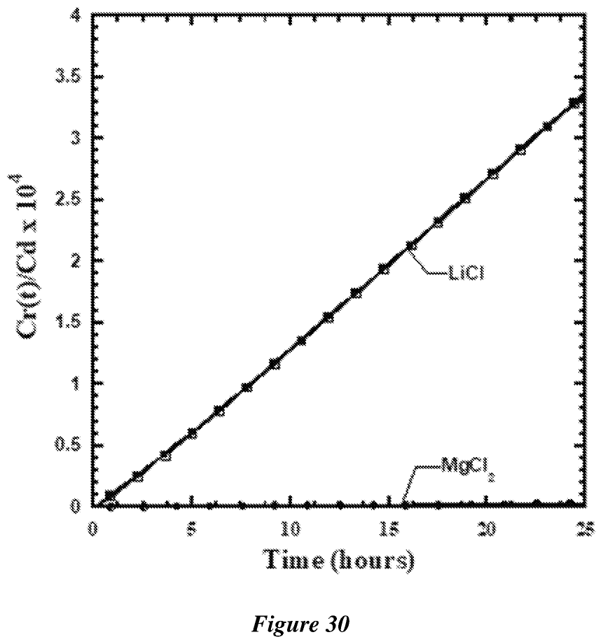

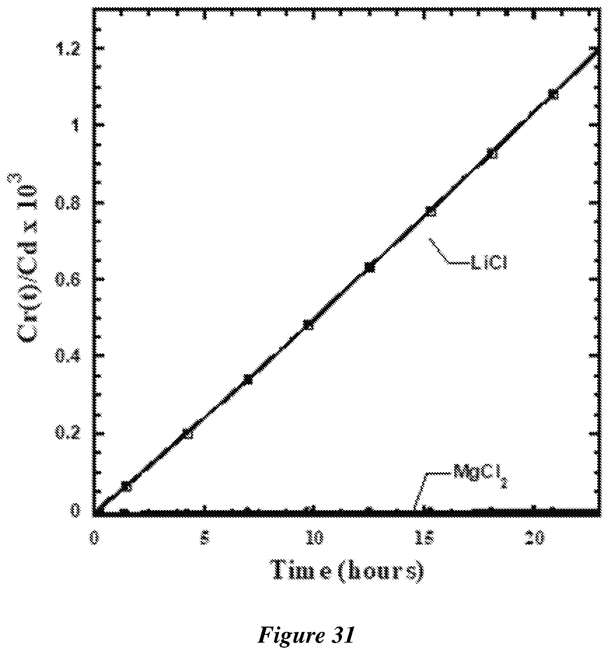

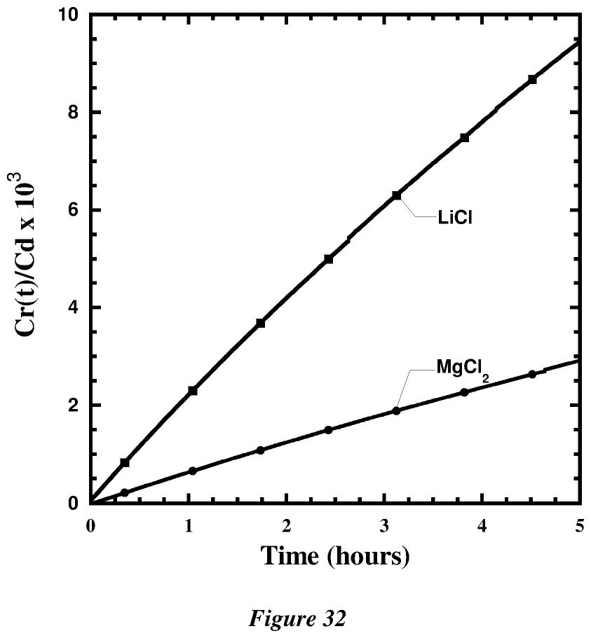

Mixed matrix membranes also were prepared comprising various amounts of cellulose acetate (CA) and UiO-66, and tested for permeability and selectivity at different MMM thicknesses, as shown in Tables 9-10 and FIGS. 28-32. To prepare 40 wt. % UiO-66-(COOH)₂ in CA, 0.5 g of UiO-66-UiO-66-(COOH)₂ was added to 4 g of tetrahydrofuran and labeled solution 1. Solution 1 was ultrasonicated at intervals of 1 second sonication on, 5 seconds sonication off, for 2 hours. Solution 1 was then left to stir on a stir plate overnight. 0.75 g of CA 2.45 was added to 36.75 g tetrahydrofuran and labeled solution 2. Solution 2 was stirred overnight. 7.5 g of solution 2 was added to solution 1. Solution 1 was then vortex mixed for 2 minutes, then ultrasonicated at intervals of 1 second sonication on, 5 seconds sonication off, for 2 hours. After ultrasonication, the remainder of solution 2 was again added to solution 1. Solution 1 was then vortex mixed for 2 minutes, then ultrasonicated at intervals of 1 second sonication on, 5 seconds sonication off, for 2 hours.

Solution 1, now containing 0.75 grams of CA 2.45 and 36.75 g more tetrahydrofuran, was then poured into a glass dish. This glass dish was set onto a leveled plate in a fume hood, to ensure an even coating of solution 1 on the glass dish, and was covered by a cone and left to evaporate the tetrahydrofuran for 24 hours. Afterwards, the glass dish was removed from the fume hood and the 40 wt % UiO-66-(COOH)₂ in CA 2.45 film was placed in a vacuum chamber at 50 degrees Celsius for 4 hours. The film was then removed, cooled to room temperature, and stored in a desiccator for future testing. The 50 micron thick 40 wt. % UiO-66-(COOH)₂ in CA MMM was tested for permeability and selectivity, as shown in Tables 9-10 and FIG. 28.

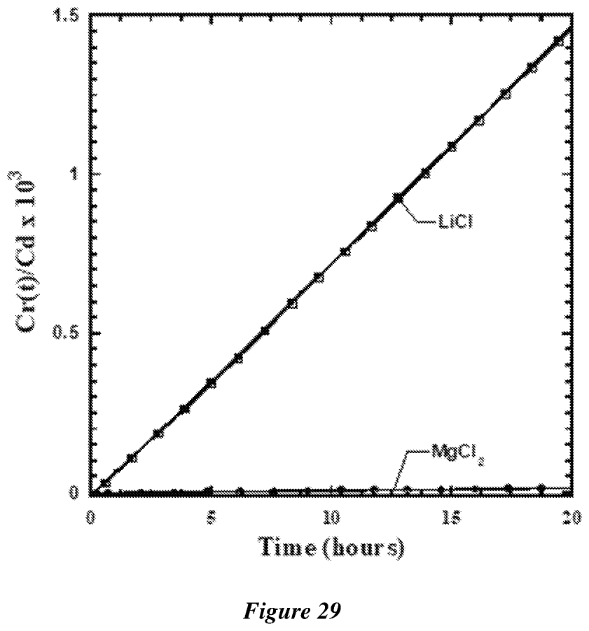

In addition, films containing 30, 28.5, and 0 wt. % UiO-66-(COOH)₂ in CA were prepared in a similar manner and tested for permeability and selectivity at different MMM thicknesses (10, 70, and 100 microns), as shown in Tables 9-10 and FIGS. 29-32. The UiO-66-(COOH)₂ in cellulose acetate MMMs also exhibited excellent LiCl/MgCl₂ selectivities.

By comparison, Table 11 shows permeability and selectivity measurements of MMMs that we prepared comprising UiO-66-(COOH)₂ in polyvinylidene fluoride (PVDF), disulfonated poly(arylene ether sulfone) (BPS-20), and polyether block amide (Pebax® 2533 SA 01 made by Arkema (PEBAX 2533)). Without wishing to be bound by theory, the relatively low selectivities of these MMM materials arose from possible polymer/MOF interfacial defects in the case of PVDF and PEBAX 2533, and possible permeability of the continuous polymer matrix in the case of BPS-20.

TABLE 9
Permeation and Selectivity of Compositions of UiO-66-2(COOH) in Cellulose Acetate - CA - 398 -
6 (CA 2.45) and Cellulose Acetate - CA - 320S, produced by Eastman, at differing thicknesses.

| Thickness, | | | | | |
|---|---|---|---|---|---|
| Salt | | NaCl Permeability | LiCl Permeability | MgCl₂ Permeability | |
| Concentration | Membrane | (cm²/s) | (cm²/s) | (cm²/s) | S_{Li+/Mg2+} |
| 50 micron, | 40 wt. % UiO-66- | 1.60E−09 | 1.23E−09 | 3.11E−11 | 39.5 |
| 1 Molar | 2(COOH) in CA 2.45 | | | | |
| 10 micron, | 30 wt. % UiO-66- | Not Measured | 4.76E−10 ± 1.35E−10 | 1.81E−11 ± 1.00E−11 | 26.3 ± 16.3 |
| 1 Molar | 2(COOH) in CA 2.45 | | | | |
| 100 micron, | 28.5 wt. % UiO-66- | 1.03E−9 ± 1.18E−10 | 7.49E−10 ± 5.23E−11 | 8.00E−12 ± 1.16E−12 | 93.6 ± 15.1 |
| 1 Molar | 2(COOH) in CA 2.45 | | | | |
| 10 micron, | CA 2.45 | 8.73E−10 ± 1.35E−10 | 1.82E−10 ± 2.50E−12 | 3.17E−12 ± 1.63E−12 | 57.4 ± 29.5 |
| 1 Molar | | | | | |
| 70 micron, | CA 1.75 | 2.30E−07 | 9.21E−08 | 2.65E−08 | 3.5 |
| 1 Molar | | | | | |

TABLE 10
Density and Water Uptake of Various Polymers and Mixed Matrix Membranes

| Thickness, | | Density | Water Uptake |
|---|---|---|---|
| Salt Concentrations | Membrane | (g/cm³) | (g_{Water}/g_{Membrane}) |
| 50 micron, | 40 wt. % UiO-66- | 1.39 ± 0.02 | 0.07 ± 0.003 |
| 1 Molar | 2(COOH) in CA 2.45 | | |
| 100 micron, | 28.5 wt. % UiO-66- | 1.09 ± 0.02 | 0.42 ± 0.003 |
| 1 Molar | 2(COOH) in CA 2.45 | | |
| 10 micron, | CA 2.45 | 1.31 ± 0.01 | 0.09 ± 0.004 |
| 1 Molar | | | |
| 70 micron, | CA 1.75 | 1.32 ± 0.006 | 0.22 ± 0.05 |
| 1 Molar | | | |

TABLE 11
Permeability and Selectivity Measurements of Polyvinylidene Fluoride (PVDF), disulfonated poly(arylene
ether sulfone) (BPS-20), and Polyether block amide Pebax ® 2533 SA 01 made by Arkema (PEBAX 2533).

| Thickness, | | NaCl Permeability | LiCl Permeability | MgCl₂ Permeability | |
|---|---|---|---|---|---|
| Salt Concentration | Membrane | (cm²/s) | (cm²/s) | (cm²/s) | S_{Li+/Mg2+} |
| 60 micron, | 30 wt. % UiO-66- | 1.9611−10 | 1.40E−10 | 1.32E−10 | 1.06 |
| 0.3 Molar | 2(COOH) in PVDF | | | | |
| ~100 micron, | 40 wt. % UiO-66- | Not Measured | 3.74E−8 ± 8.28E−9 | 4.69E−8 ± 3.48E−8 | 0.80 ± 0.62 |
| 1 Molar | 2(COOH) in BPS-20 | | | | |
| 93 micron, | 40 wt. % UiO-66- | 4.1711−11 | 4.10E−11 | 2.32E−11 | 1.77 |
| 1 Molar | 2(COOH) in PEBAX 2533 | | | | |

### Example 7

This Example describes an alternative mixing procedure involving fabrication of mixed-matrix membranes with cellulose acetate.

A polymer solution dope to contain 6:4 cellulose acetate (Eastman Kodak, ds 2.45) to UiO-66-(COOH)₂ MOF and 9:1 tetrahydrofuran to cellulose acetate, by mass, is mixed in the following manner. MOF and anhydrous tetrahydrofuran are mixed in a sealed vial and mixed via sonication bath to break up and exfoliate the MOF particles. In four additions, ⅛, ⅛, ¼, and ½, respectively, of the dry polymer powder are added to the vial, with the vial being sealed and mixed until the solution appears homogeneous between each addition. Approximately three hours of stirring is provided between each addition. The resulting solution has a color and consistency reminiscent of PVA glue. The dope solution can be cast via evaporation, or via non-solvent induced film deposition, methods as described herein.

### Example 8

This Example describes fabrication and testing of cellulose acetate-MOF composite membranes produced via evaporation or nonsolvent-induced film deposition (NIFD).

A film of approximately 5 microns thickness was fabricated via a nonsolvent-induced film deposition process by casting the aforementioned cellulose acetate-MOF dope solution onto a glass plate at a casting thickness of 30 microns, then immersing the polymer film in a nonsolvent solution of 7.5 molal lithium chloride in water. The resulting film was non-porous. A similar film was manufactured utilizing a 50:50 mixture of glycerol and water (by mass) as the nonsolvent in lieu of 7.5 molal lithium chloride solution. The resulting film was non-porous, and approximately 5 microns thick, but had less transparency than the film produced in 7.5 molal lithium chloride. A similar film was produced by instead evaporating the solvent in air for 10 minutes. The resulting film was non-porous and approximately 5 microns thick. The resulting films were immersed in DI water for storage overnight before testing.

A sample of each of the resulting films was tested in an ion permeation apparatus. Testing using 1.0 M solutions of LiCl and MgCl₂, sequentially, and repeating the test sequence twice, the Li/Mg selectivity of the mixed-matrix membrane film produced in 7.5 molal LiCl solution was found to be on the order of 124 (Table 12). The Li/Mg selectivity of the evaporated film was found to be on the order of 62 (Table 12). The selectivity of the film produced in a 50:50 mixture of glycerol and water had lower selectivity, on the order of 24.6, and developed a defect after the first test (Table 12).

TABLE 12
Single-salt permeability/selectivity characterization for membranes produced
via evaporation and nonsolvent-induced film deposition (NIFD).

| | Run | Test | | | |
|---|---|---|---|---|---|
| | time | Compound | Permeability | Li⁺/Mg²⁺ | |
| Membrane | (hour) | (mol/L) | (cm²/s) | Selectivity | Average |
| Cellulose | LiCl 1: | LiCl | 7.46e−11 | Run 1: 53.8 | LiCl |
| acetate | 21:26:10 | (1.0M) | | Run 2: 71.1 | Permeability: |
| ds 2.45 | LiCl 2: | | 8.90e−11 | | 8.18e−11 |
| Evaporative | 17:56:55 | | | | MgCl₂ |
| cast (5 μm) | | | | | |
| | MgCl₂ 1: | MgCl₂ | 1.39e−12 | | Permeability: |
| | 27:25:10 | (1.0M) | | | 1.32e−12 |
| | MgCl₂ 2: | | 1.25e−12 | | Li⁺/Mg²⁺ |
| | 21:49:05 | | | | Selectivity: |
| | | | | | 62.0 |
| Cellulose | LiCl 1: | LiCl | 3.87e−10 | Run 1: 105.3 | LiCl |
| acetate | 21:26:10 | (1.0M) | | Run 2: 142.7 | Permeability: |
| ds 2.45 | LiCl 2: | | 4.9e−10 | | 4.39e−10 |
| 7.5 m LiCl | 17:56:55 | | | | MgCl₂ |
| NIFD cast | MgCl₂ 1: | MgCl₂ | 3.68e−12 | | Permeability: |
| (5 μm) | 27:25:10 | (1.0M) | | | 3.57e−11 |
| | MgCl₂ 2: | | 3.45e−12 | | Li⁺/Mg²⁺ |
| | 21:49:05 | | | | Selectivity: |
| | | | | | 124.0 |
| Cellulose | LiCl 1: | LiCl | 2.7e−10 | Run 1: 24.6 | LiCl |
| acetate | 21:26:10 | (1.0M) | | Run 2: Failed | Permeability: |
| ds 2.45 | LiCl 2: | | Failed | | 2.7e−10 |
| 50:50 | Failed | | | | MgCl₂ |
| Glycerol/Water | MgCl₂ 1: | MgCl₂ | 1.10e−11 | | Permeability: |
| NIFD cast | 27:25:10 | (1.0M) | | | 1.10e−11 |
| (5 μm) | MgCl₂ 2: | | Failed | | Li⁺/Mg²⁺ |
| | Failed | | | | Selectivity: |
| | | | | | 24.6 |

### Example 9

This Example describes testing cellulose acetate-MOF composite membranes on natural lithium-containing brine.

A sample of natural lithium-containing brine containing ˜80,000 ppm Mg²⁺; ˜19,000 ppm Li⁺; ˜5400 ppm potassium, sodium, and calcium combined; with the anion balance consisting predominately of chloride (>99.5%); and with trace amounts of sulfate and boron, was used as a challenge solute for a cellulose acetate-MOF MMM fabricated by the above procedure. The brine was free of silt and foulants and had a pH of approximately 4.5 and a specific gravity of ˜1.5. The concentration of samples of the brine and the result of the permeation test were analyzed via optical emission spectroscopy (OES) using a Varian ICP-OES with the 2-3 strongest characteristic wavelengths investigated for each element. A standard addition method was used to assay each compound, utilizing 0, 1, 2, and 3 ppm spikes of each analyte.

The permeation test was conducted in the standard manner over the course of 22.48 hours. At the end of the test, the components of the receptor cell were assayed via OES, and the resulting Li:Mg selectivity (α_{Li:Mg}) was calculated via the following relation:

$${α}_{Li : Mg} = \frac{{c}_{Li , final}}{{c}_{Li , initial}} \frac{{c}_{Mg , initial}}{{c}_{Mg , final}}$$

The resulting selectivity was found to be ˜127.9 (Table 13), which is comparable to that measured via the single salt permeation tests using 1.0 M feed LiCl and MgCl₂ (˜6000 ppm Li and ˜19000 ppm Mg, respectively).

TABLE 13
Results of lithium/magnesium selective permeation from a natural lithium-containing
brine for a membrane produced via nonsolvent-induced film deposition.

| | | ppm at | ppm in | Permeability | Selectivity relative |
|---|---|---|---|---|---|
| | Species | Start | permeate | (cm²/s) | to Li (Li:X) |
| Cellulose | Li | 19,000 | 249.39 ± 1.23 | 8.03e−10 | 1.00 |
| acetate | Mg | 80,000 | 8.21 ± 0.88 | 6.28e−12 | 127.92 |
| ds 2.45 | | | | | |
| 7.5 m LiCl | | | | | |
| NIFD cast | | | | | |
| (5 μm) | | | | | |

### Example 10

This Example describes testing cellulose acetate-MOF composite membranes for separating monovalent vs. divalent anions.

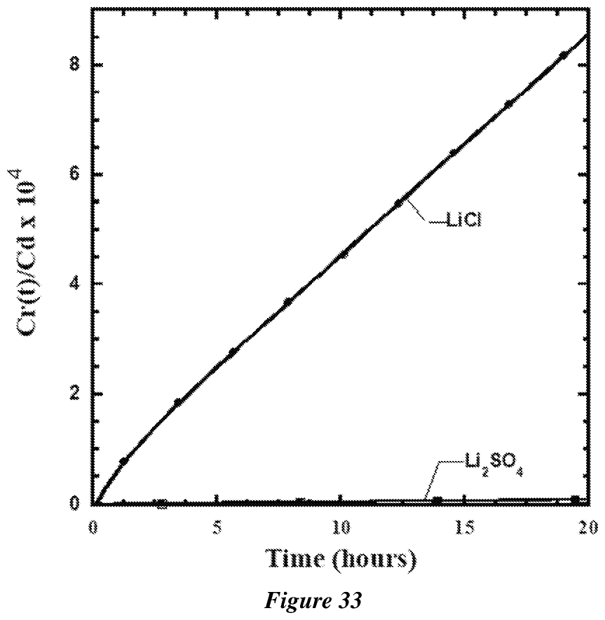

Specifically, a 30 micron thick MMM comprising 30 wt. % UiO-66-2(COOH) and cellulose acetate (CA, 2.45) was fabricated. The resulting film was tested in an ion permeation apparatus using 1.0 M solutions of LiCl and Li₂SO₄, sequentially. The Cl⁻/SO₄²⁻ selectivity (e.g., monovalent ion/divalent ion selectivity) was found to be on the order of 130. The Permeability and selectivity measurements for the MMM are shown in Table 14 and FIG. 33.

TABLE 14
Permeability and selectivity measurements on a 30 micron thick 30
wt. % UiO-66-2(COOH) in CA 2.45. Specifically measuring LiCl vs Li₂SO₄ to compare
Cl⁻ vs SO4²⁻ selectivity and permeabilities.

| Salt | | LiCl | Li₂SO₄ | |
|---|---|---|---|---|
| Concentration | | Permeability | Permeability | |
| (Molar) | Membrane | (cm²/s) | (cm²/s) | S_{LiCl/Li2SO4} |
| 1 | 30 wt. % UiO-66- | 6.48E−10 ± 4.24E−11 | 5.02E−12 ± 6.08E−13 | 129.1 ± 17.8 |
| | 2(COOH) in CA | | | |
| | 2.45 | | | |

The compositions, devices, and methods of the appended claims are not limited in scope by the specific devices and methods described herein, which are intended as illustrations of a few aspects of the claims and any devices and methods that are functionally equivalent are within the scope of this disclosure. Various modifications of the compositions, devices, and methods in addition to those shown and described herein are intended to fall within the scope of the appended claims. Further, while only certain representative compositions, devices, and methods, and aspects of these compositions, devices, and methods are specifically described, other compositions, devices, and methods and combinations of various features of the compositions, devices, and methods are intended to fall within the scope of the appended claims, even if not specifically recited. Thus a combination of steps, elements, components, or constituents can be explicitly mentioned herein; however, all other combinations of steps, elements, components, and constituents are included, even though not explicitly stated.

1-10. (canceled)

11. A mixed matrix membrane for separating a target ion from a non-target ion in a liquid medium, the mixed matrix membrane comprising:
a plurality of metal organic framework particles dispersed in a continuous polymer phase, wherein each of the plurality the metal organic framework particles comprises a channel traversing the metal organic framework particle from a first pore window to a second pore window, wherein the first pore window and the second pore window have an average pore window diameter;
wherein the target ion has a target ion crystal diameter and a target ion solvated diameter in the liquid medium;
wherein the non-target ion has a non-target ion crystal diameter and a non-target ion solvated diameter in the liquid medium;
wherein the average pore window diameter is greater than the target ion crystal diameter and less than or equal to the target ion solvated diameter;
wherein the target ion crystal diameter is smaller than the non-target ion crystal diameter and the target ion has a lower energy of solvation than the non-target ion;
wherein the mixed matrix membrane has a first surface and a second surface, with an average thickness therebetween;
wherein the plurality of metal organic framework particles have an average particle size, the average particle size being less than the average thickness of the mixed matrix membrane;
wherein at the channels of at least a portion of the plurality of metal organic framework particles form a percolation channel that traverses the average thickness of the mixed matrix membrane from the first surface to the second surface.

12. The mixed matrix membrane of claim 11, wherein in the absence of the plurality of metal organic framework particles the continuous polymer phase is substantially less permeable to the target ion, the non-target ion, and the liquid medium than the plurality of metal organic framework particles;
such that the mixed matrix membrane is permeable to at least the target ion and the liquid medium via the percolation channel.

13-20. (canceled)

21. The mixed matrix membrane of claim 11, wherein:
the plurality of metal organic framework particles comprise UiO-66, ZIF, HKUST-1, UiO-66-(COOH)₂, UiO-66-NH₂, UiO-66-SO₃H, UiO-66-Br, ZIF-8, ZIF-7, derivatives thereof, or combinations thereof; and
the continuous polymer phase comprises poly(amide imide), poly(ether-b-amide), polysulfone, a polymer derived from bisphenylsulfone, polyimide, polyether sulfone, polyphenylsulfone, polyvinylidene difluoride (PVDF), polybenzimidazole (PBI), polyamide, polyimide, cellulose acetate, Matrimid, Torlon, derivatives thereof, or combinations thereof.

22. The mixed matrix membrane of claim 11, wherein the plurality of metal organic framework particles have an average particle size of from 1 nm to 10 μm.

23. The mixed matrix membrane of claim 11, wherein the average particle size the plurality of metal organic framework particles is less than the average thickness of the mixed matrix membrane by an order of magnitude.

24. The mixed matrix membrane of claim 11, wherein the average pore window diameter is from 1 Å to 1 nm.

25-79. (canceled)

80. A method comprising separating a target ion from a non-target ion in a liquid medium using a mixed matrix membrane, wherein the mixed matrix membrane comprises a plurality of metal organic framework particles dispersed in a continuous polymer phase.

81-87. (canceled)

88. The method of claim 80, wherein the plurality of metal organic framework particles comprise UiO-66, ZIF, HKUST-1, UiO-66-(COOH)₂, UiO-66-NH₂, UiO-66-SO₃H, UiO-Br, ZIF-8, ZIF-7, derivatives thereof, or combinations thereof.

89. The method of claim 80, wherein the plurality of metal organic framework particles have an average particle size of from 1 nm to 10 μm.

90. The method of claim 80, wherein the continuous polymer phase comprises a hydrophobic polymer, an amorphous polymer, or a combination thereof.

91. The method of claim 80, wherein the continuous polymer phase comprises poly(amide imide), poly(ether-b-amide), polysulfone, a polymer derived from bisphenylsulfone, polyimide, polyether sulfone, polyphenylsulfone, polyvinylidene difluoride (PVDF), polybenzimidazole (PBI), polyamide, polyimide, cellulose acetate, Matrimid, Torlon, derivatives thereof, or combinations thereof.

92-98. (canceled)

99. The method of claim 80, wherein the mixed matrix membrane comprises from greater than 0% to 90% by weight of the plurality of metal organic framework particles relative to the mixed matrix membrane.

100-105. (canceled)

106. The method of claim 80, wherein the mixed matrix membrane has an average thickness of from 50 nm to 50 μm.

107-109. (canceled)

110. The method of claim 80, wherein the method exhibits a selectivity for the target ion over the non-target ion of from 2 to 2000.

111. (canceled)

112. The method of claim 80, wherein the liquid medium comprises water, tetrahydrofuran (THF), N-methyl-2-pyrrolidone (NMP), dimethylformamide (DMF), dimethyl sulfoxide (DMSO), dimethylacetamide, dichloromethane (CH₂Cl₂), ethylene glycol, ethanol, methanol, propanol, isopropanol, acetonitrile, chloroform, acetone, hexane, heptane, toluene, methyl acetate, ethyl acetate, or combinations thereof.

113-117. (canceled)

118. The method of claim 80, wherein the target ion comprises Li⁺ and the non-target ion comprises Na⁺, K⁺, Rb⁺, F⁻, NO₃²⁻, Mg²⁺, Ca²⁺, SO₄²⁻, Cl⁻, or a combination thereof.

119-127. (canceled)

128. A mixed matrix membrane comprising a plurality of metal organic framework particles dispersed in a continuous polymer phase, wherein the continuous polymer phase comprises a cellulose polymer and the mixed matrix membrane exhibits a Li to Mg selectivity of at least 53.8:1.

129. The mixed matrix membrane of claim 128, wherein the mixed matrix membrane exhibits a Li to Mg selectivity in the range of from 53.8:1 to 142.7:1.

130. The mixed matrix membrane of claim 128, wherein the plurality of metal organic framework particles comprise UiO-66 or a derivative thereof.

131. The mixed matrix membrane of claim 128, wherein the cellulose polymer comprises cellulose acetate.
